(19) United States
(12) Patent Application Publication
(10) Pub. No.: US 2025/0245398 A1
(43) Pub. Date: Jul. 31, 2025

(54) METHOD AND SYSTEM FOR NUMERICALLY DEFINING A REBAR-CONCRETE INTERFACE ELEMENT UNDER BOTH MONOTONIC AND CYCLIC LOADING

(71) Applicant: WUHAN UNIVERSITY, Hubei (CN)

(72) Inventors: Le HUANG, Hubei (CN); Zhihao TONG, Hubei (CN); Lihua XU, Hubei (CN); Chunlei YU, Hubei (CN); Hongxuan TU, Hubei (CN); Benhao GAO, Hubei (CN); Yin CHI, Hubei (CN)

(73) Assignee: WUHAN UNIVERSITY, Hubei (CN)

(21) Appl. No.: 19/023,294

(22) Filed: Jan. 16, 2025

(30) Foreign Application Priority Data
Jan. 26, 2024 (CN) 202410115361.4
Nov. 18, 2024 (CN) 202411639725.5

(51) Int. Cl. G06F 30/23; G06F 30/12; G06F 111/10; G06T 17/20

(52) U.S. Cl. CPC G06F 30/23; G06F 30/12; G06T 17/20; G06F 2111/10

(57) ABSTRACT

This invention discloses a method and system for numerically defining a rebar-concrete interface element under both monotonic and cyclic loading, comprising: first, establishing a finite element model of reinforced concrete component, and generating a solver input file within the finite element software; then, adding a series of user-defined interface elements in the solver input file; then, inputting parameters of characteristic points of the axial bond-slip curve between rebar and concrete, the diameter of rebar, and the characteristic parameters of fibers associated with the user-defined element (UEL) in the solver input file; then, setting the element stiffness matrix, the coordinate transformation matrix and residual in the UEL subroutine; finally, submitting the solver input file in the finite element software, and calling the UEL subroutine for calculation.

### CROSS-REFERENCE TO RELATED APPLICATION

This application claims the priority benefit of China application serial no. 202410115361.4, filed on Jan. 26, 2024, and China application serial no. 202411639725.5, filed on Nov. 18, 2024. The entirety of the above-mentioned patent application is hereby incorporated by reference herein and made a part of this specification.

### BACKGROUND

### Technical Field

This invention belongs to the technical field of numerical simulation methods for reinforced concrete structures, in particular to a numerical establishment method and system for rebar-concrete interface element, as well as a numerical establishment method for rebar-concrete interface element subjected to cyclic loading.

### Description of Related Art

The reliable bond between rebar and surrounding concrete is crucial to guarantee the integrity of reinforced concrete (RC) structures, as it significantly influences load-deflection behavior, reinforcement anchorage length, structural stiffness, and deformation capacity. In practice, considerable slip or even debonding between the rebar and concrete may occur when subjected to earthquake, overloading, or other harsh service conditions, leading to substantial alterations in the mechanical performance of RC structures. Therefore, to facilitate a comprehensive evaluation of mechanical responses of RC structures under complex loading, it is imperative to take the interfacial bond-slip behavior between these two distinct materials into consideration. Given this, extensive endeavors, including tailored experimental investigations and refined numerical simulations, have been devoted to this open issue. Nevertheless, experimental studies are normally time-consuming, costly, and challenging for revealing damage mechanisms intuitively; in contrast, finite element analysis offers advantages in terms of cost-effectiveness and the ability to monitor the evolution of internal damage.

Over the past few decades, numerous models have been developed to account for the bond-slip behavior between rebar and concrete, which can be broadly classified into two categories: embedded models and discrete models. Among them, embedded models are designed to reflect the slip of rebar indirectly by adjusting the material properties of either the rebar or the concrete. However, despite being computationally efficient, these models are primarily employed in fiber model simulations for individual components or structures. With advancements in computational methods, discrete models have emerged, in which specific connections or interface elements are introduced into the rebar-concrete interface, and positioned with matching bond-slip relationships. For instance, the link model entailed the addition of linear elastic zero-length springs to the common nodes of rebar and concrete elements, and represented the bond-slip behavior by governing the relative displacement between the nodes through these springs. Upon the adjustment of the tangential and normal stiffnesses of springs, the model allowed for the consideration of the variation of bond-slip relationships. On this basis, nonlinear spring elements are further developed to achieve a more sophisticated simulation of RC structures. In addition to these, connector elements or contact layers have also been adopted to characterize the bond responses between rebar and concrete. Due to their theoretical simplicity and accessibility, discrete models have been in widespread utilization in refined nonlinear analysis of RC structures.

However, most of the aforementioned discrete elements tend to elastically unload back to their original state, making it challenging to capture the residual slip during the unloading stage. As a result, they are generally unsuitable for cyclic and cyclic loading conditions. To address this limitation, multi-nodal interface elements have been proposed as an alternative to model the bond-slip behavior between rebar and concrete. In recent years, many scholars have implemented a four-node zero-thickness interface element upon the UEL subroutine, which is able to properly capture the residual bond stress under cyclic loading. Nevertheless, the majority of current rebar-concrete interface elements are intrinsically one-dimensional, focusing primarily on the shear stress along the axial direction of the rebar. This limitation hinders a comprehensive representation of interfacial damage mechanisms, especially under inadequate constraint conditions, which could lead to an underestimation of concrete damage in the nonlinear numerical analysis of RC structures.

### SUMMARY

In order to solve the above technical problems, this invention develops a numerical establishment method and system for rebar-concrete interface element, as well as a numerical establishment method for rebar-concrete interface element subjected to cyclic loading, which represents the bond-slip behavior between rebar and concrete more realistically, achieving a compromise between accuracy and computational efficiency.

The technical solution of the present invention is: first, an efficient approach for generating the interface element using a program is introduced. Afterward, the constitutive law under monotonic and cyclic loading of the interface element is elaborated, followed by the numerical implementation method. Finally, extensive independent verifications are conducted at both the material and component levels to verify the applicability and rationalization of the proposed interface element.

A numerical establishment method for rebar-concrete interface element, wherein the detailed implementation includes following steps:
Step 1: based on actual condition, a finite element model of the reinforced concrete component is established in a finite element software, whereby a discrete model is formed after being meshed. Then, submitting a computational job to generate a solver input file.
Step 2: adding user-defined interface elements to the solver input file and entering element numbers and node numbers for these user-defined interface elements.
Step 3: based on actual material parameters, inputting characteristic point parameters of an axial bond-slip curve between rebar and concrete, a diameter of rebar, and characteristic parameters of fibers in the user-defined element information of the solver input file.
Step 4: setting an element stiffness matrix in a local coordinate system, a coordinate transformation matrix, and a residual of the user-defined interface element.
Step 5: submitting the solver input file in the finite element software and executing calculations based on step 4.

More specifically, when establishing the finite element model in step 1, solid elements are used for both longitudinal rebars and concrete, whereas truss elements are used for remaining rebars. Meanwhile, rebar ribs are not required to be established. Longitudinal rebar elements of the described discrete model are co-noded with concrete elements.

More specifically, the user-defined interface elements described in step 3 are four-node zero-thickness elements. Further setting a number of solution-dependent state variables and numbers and values of element properties, while activating the translational degrees of freedom in the X, Y, and Z directions. The described user-defined interface element is first set with an element number and then four node numbers in the solver input file, in which node 1 and node 4 are positioned in concrete elements, and node 2 and node 3 are positioned in rebar elements.

More specifically, the described numbers of the element properties are set according to requirements, including the diameter of the rebar, fiber characteristic parameters, concrete cubic compressive strength, initial bond stiffness, and coordinates of two other directions except an axial direction for a midpoint of a rebar section in a global coordinate system.

More specifically, the element stiffness matrix in the step 4 is a 12-order square matrix, including stiffnesses of the user-defined interface elements in U, V, and W directions in the local coordinate system. The coordinate transformation matrix described in the step 4 is also a 12-order square matrix, facilitating transformation of the element stiffness matrix from the local coordinate system to the global coordinate system. The residual is a matrix of 12 rows and 1 column, calculated by subtracting an internal force from an external force, in which the external force is automatically calculated by the finite element software, while the internal force is the element stiffness matrix multiplied by an element displacement matrix in the global coordinate system.

More specifically, the element stiffness matrix in the local coordinate system is obtained by assembling the stiffness matrices of directions U, V, and Win the local coordinate system by the global coordinate method, in which the stiffness matrix of U direction describes the relationship between axial bond stress and a slip, the stiffness matrix of V direction stiffness matrix describes the relationship between a radial stress and the slip, and the stiffness matrix of W direction stiffness matrix describes stiffness of a rebar in torsion direction, as shown in Eqs. (1)-(3).

$$[ {K}_{w} ] = \frac{1}{6} {k}_{w} π dl [ \begin{matrix}2 & - 2 & - 1 & 1 \\ - 2 & 2 & 1 & - 1 \\ - 1 & 1 & 2 & - 2 \\ 1 & - 1 & - 2 & 2\end{matrix} ] \qquad ( 1 )$$

$$[ {K}_{v} ] = \frac{1}{6} {k}_{v} π dl [ \begin{matrix}2 & - 2 & - 1 & 1 \\ - 2 & 2 & 1 & - 1 \\ - 1 & 1 & 2 & - 2 \\ 1 & - 1 & - 2 & 2\end{matrix} ] \qquad ( 2 )$$

$$[ {K}_{u} ] = {k}_{u} π dl [ \begin{matrix}1 & - 1 & 0 & 0 \\ - 1 & 1 & 0 & 0 \\ 0 & 0 & 1 & - 1 \\ 0 & 0 & - 1 & 1\end{matrix} ] \qquad ( 3 )$$

Wherein, [K_{w}], [Kᵥ], and [Kᵤ] represent the stiffness matrices of the interface element in axial, radial, and torsional directions in the local coordinate system, respectively; k_{w}, kᵥ, and kᵤ represent stiffness of the interface element in axial, radial, and torsional directions in the local coordinate system, respectively; d represents the diameter of the rebar; l represents a length of the interface element in a bonding direction.

More specifically, a relationship between the axial bond stress and the slip is shown in Eqs. (4)-(7), the relationship between the axial bond stress and radial stress is shown in Eq. (10), and the stiffness of the rebar in the torsion direction is greater than or equal to 105 MPa.

$$τ = {E}_{b} \cdot s \cdot exp [ - {( \frac{s}{\sqrt[m]{m \cdot {s}_{peak}}} )}^{m} ] \qquad ( 4 )$$

$$m = {[ {ln ( \frac{{τ}_{peak}}{{E}_{b} {s}_{peak}} )}^{- 1} ]}^{- 1} \qquad ( 5 )$$

$${s}_{peak} = ( 1 + \sum {c}_{n} \cdot {λ}_{f , n} ) \times {( \frac{30}{{f}_{cu}} )}^{0.5} \qquad ( 6 )$$

$${τ}_{peak} = ( 1 + \sum {d}_{n} \cdot {λ}_{f , n} ) \times 13.5 {( \frac{{f}_{cu}}{30} )}^{0.5} \qquad ( 7 )$$

$$q = \frac{cos β - μ \cdot sin β}{sin β + μ \cdot cos β} \cdot τ \qquad ( 10 )$$

Wherein, τ and s represent the axial bond stress and slip between rebar and concrete, respectively; τₚₑₐₖ and sₚₑₐₖ represent a peak bond stress and corresponding slip, respectively; E_{b} represents the initial bond stiffness; m represents a shape parameter; λ_{f,n} represents the fiber characteristic parameter, which is the multiplication of a fiber volume fraction with aspect ratio; dₙ and cₙ represent fiber-enhanced coefficients of the peak bond stress and the corresponding slip, respectively, which can be obtained by fitting to experimental data. Particularly, the equations are applied to plain concrete when n=0, to single fiber reinforced concrete when n=1, and to hybrid fiber reinforced concrete when n≥2; f_{cu} represents a concrete cubic compressive strength; q represents a radial stress between rebar and concrete; β represents a slip angle, i.e., an angle between a concrete failure surface and the rebar; μ represents a friction coefficient between concrete and rebar.

More specifically, a transformation relationship between the element stiffness matrix in the global coordinate system and that in the local coordinate system is presented in Eq. (11), and the coordinate transformation matrixes are shown in Eqs. (12) and (13).

$$[ K ] = {[ R ]}^{T} \cdot [ {K}_{local} ] \cdot [ R ] \qquad ( 11 )$$

$$[ R ] = [ \begin{matrix}{R}_{1} & 0 & 0 & 0 \\ 0 & {R}_{2} & 0 & 0 \\ 0 & 0 & {R}_{3} & 0 \\ 0 & 0 & 0 & {R}_{4}\end{matrix} ] \qquad ( 12 )$$

$$[ {R}_{1} ] = [ {R}_{2} ] = [ {R}_{3} ] = [ {R}_{4} ] = [ \begin{matrix}{U}_{X} & {U}_{Y} & {U}_{Z} \\ {V}_{X} & {V}_{Y} & {V}_{Z} \\ {W}_{X} & {W}_{Y} & {W}_{Z}\end{matrix} ] \qquad ( 13 )$$

Wherein, [K] represents the element stiffness matrix in the global coordinate system; [K_{local}] represents the element stiffness matrix in the local coordinate system; [R] represents the coordinate transformation matrix, [R₁], [R₂], [R₃], and [R₄] represent the coordinate transformation matrices for nodes 1 to node 4, respectively; and U_{X} to W_{Z} represent the direction cosines of axes under the local coordinate system of the node to axes under the global coordinate system, respectively.

A numerical establishment system for rebar-concrete interface element, wherein the detailed implementation includes following modules.

A module for generating a solver input file: based on an actual condition, a finite element model of a reinforced concrete component is established in a finite element software, whereby a discrete model is formed after being meshed. Then, submitting a computational job to generate the solver input file.

A module for inputting user-defined element information: adding user-defined interface elements to the solver input file and entering element numbers and node numbers for the user-defined interface elements, and based on actual material parameters, inputting characteristic point parameters of an axial bond-slip curve between rebar and concrete, a diameter of rebar, and characteristic parameters of fibers in the user-defined element information of the solver input file.

Modules for programming subroutine: setting an element stiffness matrix in a local coordinate system, a coordinate transformation matrix, and a residual of the user-defined interface elements.

Modules for calculating and solving: submitting the solver input file in the finite element software and executing calculations based on the element stiffness matrix in the local coordinate system, the coordinate transformation matrix, and the residual of the modules for programming subroutine.

The described numerical establishment system for the rebar-concrete interface element is used to perform the steps in the numerical establishment method for the rebar-concrete interface element.

A numerical establishment method for rebar-concrete interface element subjected to cyclic loading, wherein the detailed implementation includes the following steps.

Furthermore, a numerical establishment method for rebar-concrete interface element subject to cyclic loading, comprising steps as follows.
Step S1: modeling a reinforced concrete component in a finite element software and meshing a corresponding model to form a discrete model. Then, inserting a layer of eight-node zero-thickness cohesive elements between rebar and concrete elements, after which the inserted cohesive elements are deleted at intervals along a circumferential direction of the rebar.
Step S2: submitting a computational job to generate a solver input file.
Step S3: reading the solver input file and converting element information of the eight-node zero-thickness cohesive elements to that of four-node zero-thickness user-defined interface elements in batch. Then, setting an element type, a number of nodes, a number of activated degrees of freedom, and material property parameters of user-defined interface elements, so as to obtain a new solver input file.
Step S4: setting a bond-slip constitutive law under cyclic loading.
Step S5: programming a user subroutine to numerically implement the bond-slip constitutive law based on the step S4.
Step S6: submitting the new solver input file from the step S3 in the finite element software and executing calculations based on the user subroutine in the step S5.

More specifically, a batch conversion process for element information from eight-node cohesive elements to four-node interface elements described in the step S3 is as follows.
Step S3.1: reading the solver input file and identifying the element information of all eight-node cohesive elements by keyword search.
Step S3.2: processing the element information of the eight-node cohesive element in turn, while marking element number Eᵢ and first two node numbers (N₁, N₂) for the eight-node cohesive element.
Step S3.3: obtaining 3D coordinates of the first two nodes for the eight-node cohesive element, recorded as (X₁, Y₁, Z₁; X₂, Y₂, Z₂), respectively.
Step S3.4: determining a bonding direction of the rebar. When the bonding direction is in a specific direction, utilize coordinate values of other two directions for computation. If an absolute value of a square sum of the coordinate values in the other two directions for a node N₁ is subtracted from that for node N₂, subsequently a calculation result is taken as an absolute value. If the calculation result is less than a tolerance, then a cohesive element being processed is a first numbering method, and a step S3.5 is executed; otherwise, the cohesive element being processed is a second numbering method, and a step S3.6 is executed.

The step S3.5: rewriting the element information of the cohesive element (E₁, N₁, N₂, N₃, N₄, N₅, N₆, N₇, N₈) into element information of two four-node interface elements (NE₁, N₅, N₁, N₄, N₈) and (NE₂, N₆, N₂, N₃, N₇). Then, executing the step S3.7.

The step S3.6: rewriting the element information of the cohesive element (E₁, N₁, N₂, N₃, N₄, N₅, N₆, N₇, N₈) into element information of two four-node interface elements (NE₁, N₈, N₄, N₃, N₇) and (NE₂, N₅, N₁, N₂, N₆). Then, executing the step S3.7.

The step S3.7: checking if there are still cohesive elements in the solver input file. If there are, loop through the steps S3.2 to S3.7 until all cohesive elements are converted into four-node interface elements. If there are none, outputting the new solver input file.

More specifically, the bond-slip constitutive law under cyclic loading described in step S4 emphasizes setting an envelope curve, an unloaded bond stiffness, a bond degradation rate, and a residual bond stress, further comprising:

The envelop curve of the step S4 is set as follows:

$$τ = {Ω}_{y} \cdot {E}_{b} \cdot s \cdot exp [ - {( \frac{s}{a} )}^{b} ] \qquad ( 15 )$$

The unloaded bond stiffness E_{ub} is consistent with an initial bond stiffness E_{b}.

The bond degradation rate is set as follows:

$${α}_{3}^{n} = {τ}_{n} / {τ}_{0} \qquad ( 22 )$$

The residual bond stress is set as follows:

$${τ}_{rev} = {α}_{4} \cdot {τ}_{unl} \qquad ( 23 )$$

Wherein, τ and s represent bond stress and slip, respectively; E_{b} represents the initial bond stiffness; Ω_{y} represents a correction coefficient considering an effect of rebar yielding on bond stress; a and b represent parameters that control a shape of the envelop curve; α₃ represents a bond degradation coefficient; τ₀ represents a monotonic bond stress to a certain slip value; in represents a cyclic bond stress of a n-th loading cycle at the same slip; n represents a cycle; Trev represents the residual bond stress; τᵤₙₗ is a bond stress at a maximum slip before unloading; α₄ represents a residual bond stress coefficient.

More specifically, the correction coefficient considering the effect of rebar yielding on bond stress is set as follows:

$${Ω}_{y} = \{ \begin{matrix}1 & ε \leq {ε}_{y} \\ 1 - 0.85 \{ 1 - exp [ - 5 {( \frac{ε - {ε}_{y}}{{ε}_{u} - {ε}_{y}} )}^{( 2 - \frac{{f}_{u}}{{f}_{y}} )} ] \} & ε > {ε}_{y}\end{matrix} \qquad ( 18 )$$

Wherein, ε represents strain of rebar; ε_{y} and εᵤ represent a yield strain and ultimate strain of rebar, respectively; f_{y} and fᵤ represent a yield stress and ultimate stress of rebar, respectively.

More specifically, the shape parameters of the envelop curve are obtained by the following equation:

$${a}^{b} = b \cdot {s}_{u}^{b} , b = - 1 / ln ( {τ}_{u} / {E}_{b} \cdot {s}_{u} ) \qquad ( 19 )$$

Wherein, τᵤ and sᵤ represent a peak bond stress and corresponding slip.

More specifically, the bond-slip constitutive law under cyclic loading is able to be implemented numerically described in the step S5 by the following steps.
Step S5.1: setting an embedded variable PROPS(⋅) to read material property parameters of the user-defined interface elements in the solver input file; calculating a slip value s, a slip increment Δs between the rebar and concrete, and a rebar strain ε; updating values of all state variables SVARS(⋅); calculating a multiplication of the slip increment Δs at a current incremental step and a slip increment Δsₚᵣₑ at a previous incremental step. If a result of the multiplication is less than zero, a number of cycles n is increased by 1, and a step S5.2 is executed; if the result of the multiplication is greater than or equal to zero, the number of cycles n remains unchanged, and a step S5.2 is executed;
The step S5.2: judging a relationship between the slip value s and a historical maximum slip value s_{max,c} in a compression state. If s<s_{max,c}, then execute a step S5.3, otherwise execute a step S5.4;
The step S5.3: updating the value of s_{max,c}, i.e., s_{max,c}=s; calculating the bond stress r; and executing a step S5.13;
The step S5.4: judging a relationship between the slip value s and 0. If s<0, execute a step S5.5, otherwise execute a step S5.8;
The step S5.5: judging a relationship between the slip increment Δs and 0. If Δs>0, execute a step S5.6, otherwise execute a step S5.7;
The step S5.6: recording a bond stress τ_{unl,c} and a slip value s_{unl,c} at an unloading point in the compression state, i.e., τ_{unl,c}=τ and s_{unl,c}=s; calculating a residual bond stress τ_{res,c} in the compression state; calculating the bond stress τ=τ_{unl,c}+E_{ub}·Δs, wherein E_{ub} is an unloading stiffness; judging when τ>τ_{unl,c}, then making τ=τ_{unl,c}; and executing the step S5.13;
The step S5.7: calculating a bond stress τ_{int,c} and a corresponding slip s_{int,c} at an intersection of a reloading curve and a reduced envelope curve in the compression state; updating a value of s_{max,c}, i.e., s_{max,c}=s; calculating the bond stress τ; and executing the step S5.13;
The step S5.8: judging a relationship between the slip value s and a historical maximum slip value s_{max,t} in a tension state. If s>s_{max,t}, then execute a step S5.9, otherwise execute a step S5.10;
The step S5.9: updating the value of s_{max,t}, i.e., s_{max,t}=s; calculating the bond stress r; and executing the step S5.13;
The step S5.10: judging a relationship between the slip increment Δs and 0. If Δs<0, execute a step S5.11, otherwise execute a step S5.12;
The step S5.11: recording a bond stress τ_{unl,t} and a slip value s_{unl,t} at the unloading point in the compression state, i.e., τ_{unl,t}=τ and s_{unl,t}=s; calculating a residual bond stress τ_{res,t} in the compression state; calculating the bond stress τ=τ_{unl,c}+E_{ub}·Δs, wherein E_{ub} is the unloading stiffness; judging when τ<τ_{unl,t}, then making τ=τ_{unl,t}; and executing the step S5.13;
The step S5.12: calculating a bond stress τ_{int,t} and a corresponding slip s_{int,t} at the intersection of the reloading curve and the reduced envelope curve in the tension state; updating the value of s_{max,t}, i.e., s_{max,t}=s; calculating the bond stress τ; and executing the Step S5.13;
The step S5.13: calculating axial bond stiffness k_{U}=τ/s; saving all state variables SVARS(⋅); assembling the element stiffness matrix based on the axial, radial, torsional direction, and axial-radial correlation stiffness matrices of the user-defined interface element; setting the coordinate transformation matrix to transform the element stiffness matrix in the local coordinate system to the global coordinate system; calculating the residuals; and proceeding to a next incremental step and executing the step S5.1.

More specifically, the bond stress τ_{int,c} and the corresponding slip s_{int,c} at the intersection of the reloading curve and the reduced envelope curve in the compression state, as well as the bond stress τ_{int,t} and the corresponding slip s_{int,t} at the intersection of the reloading curve and the reduced envelope curve in the tension state are obtained as follows:

Initially, the reloading stiffness is calculated from the bond stress and the corresponding slip at an initial reloading point, a slip at the maximum unloading point, and the bond degradation rate, subsequently, since the bond stress and slip at the initial reloading point, the reduced envelope curve, and the reloading stiffness are known, the bond stress and the corresponding slip at the intersection of the reloading curve and the reduced envelope curve are obtained through a method of the dichotomy when the error is less than a set threshold.

More specifically, the state variable SVARS(⋅) consists of the number of cycles n, slip s, the slip increment Δs, the slip increment of the previous incremental step Δsₚᵣₑ, the bond stress τ_{int,c} and the corresponding slip s_{unl,c} at the intersection of the reloading curve and the reduced envelope curve in the compression state, the bond stress τ_{int,t} and the corresponding slip s_{unl,t} at the intersection of the reloading curve and the reduced envelope curve in the tension state, the residual bond stresses τ_{res,c} and τ_{res,t}, and the historical maximum slip values s_{max,c} and s_{max,t}.

Meanwhile, a numerical establishment system for rebar-concrete interface element subjected to cyclic loading, wherein the detailed implementation includes following modules.

A module for modeling: modeling a reinforced concrete component in a finite element software and meshing it to form a discrete model. Then, inserting a layer of eight-node zero-thickness cohesive elements between rebar and concrete elements, after which the cohesive elements are deleted at intervals along circumferential direction of the rebar.

A module for generating a solver input file: submitting a computational job to generate the solver input file.

A module for updating the solver input file: reading the solver input file and converting element information of the eight-node zero-thickness cohesive elements to that of the four-node zero-thickness user-defined interface elements in batch. Then, setting the element type, number of nodes, number of activated degrees of freedom, and material property parameters of the user-defined interface elements, so as to obtain a new solver input file.

Modules for setting constitutive law: setting a bond-slip constitutive law under cyclic loading.

Modules for programming subroutine: program a user subroutine to numerically implement the bond-slip constitutive law based on the modules for setting constitutive law.

Modules for calculating and solving: submitting the new solver input file from the module for updating the solver input file in the finite element software and executing calculations based on the modules for programming subroutine.

The described numerical establishment system for rebar-concrete interface element subjected to cyclic loading is used to perform the steps in the numerical establishment method for rebar-concrete interface element subjected to cyclic loading.

The beneficial effects of the present invention are: This invention can not only consider the shear stress transmitted along the axial direction of the rebar, but also consider the compressive stress transmitted along the radial direction of the rebar, which applies to monotonic and cyclic loading conditions. In addition, the modeling results show that this invention effectively improves the computational efficiency and accuracy of the nonlinear analysis of reinforced concrete structures.

To make the aforementioned more comprehensible, several embodiments accompanied with drawings are described in detail as follows.

### BRIEF DESCRIPTION OF THE DRAWINGS

FIG. 1 is a flowchart in embodiment 1 of the present invention.

FIG. 2 is a user subroutine flowchart in embodiment 1 of the present invention.

FIG. 3 is a schematic diagram of the interface stress during rebar slippage in embodiment 1 of the present invention.

FIG. 4 is a schematic diagram of force and coordinate transformation of interface elements in embodiment 1 of the present invention.

FIG. 5 is a schematic diagram of the failure mode of the center pull-out specimen in embodiment 1 of the present invention.

FIG. 6 is a comparison of the force-displacement curve of the center pull-out specimen in embodiment 1 of the present invention with the theoretical solution.

FIG. 7 is a flowchart in embodiment 3 of the present invention.

FIG. 8 is a schematic diagram of the interface element deletion at intervals in embodiment 3 of the present invention.

FIG. 9 is a flowchart of the element conversion in embodiment 3 of the present invention.

FIG. 10 is a schematic diagram of the element conversion in embodiment 3 of the present invention.

FIG. 11 is a schematic diagram of the constitutive law under cyclic loading in embodiment 3 of the present invention.

FIG. 12 is a flowchart of the numerical implementation of the constitutive law in embodiment 3 of the present invention.

FIG. 13 is a schematic diagram of the residual calculation in embodiment 3 of the present invention.

FIG. 14 is a schematic diagram of the model in embodiment 4 of the present invention.

FIG. 15 is a comparison of the bond-slip curve in embodiment 4 of the present invention with the experimental result.

FIG. 16 is a schematic diagram of the specimen dimensions and numerical modeling in embodiment 5 of the present invention.

FIG. 17 is a schematic diagram of the failure stage in embodiment 5 of the present invention.

FIG. 18 is a comparison of the load-displacement curve in embodiment 5 of the present invention with the experimental result.

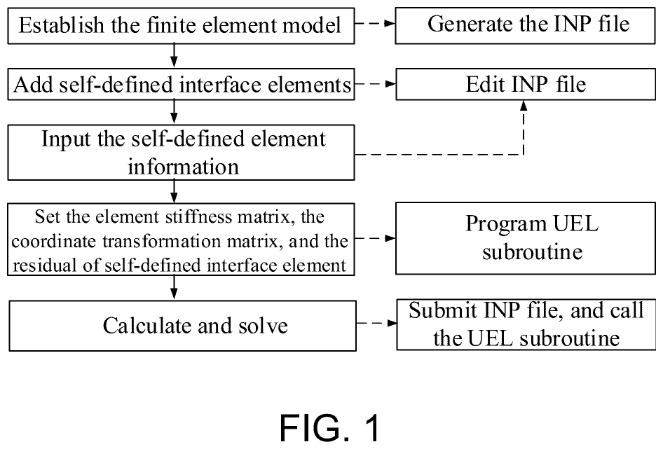

### DESCRIPTION OF THE EMBODIMENTS

In order to facilitate those of ordinary skill in the related research fields to understand and implement the present invention, the details of the present invention will be described below in conjunction with the drawings and embodiments. It should be understood that the implementation examples described here are only for illustration and explanation of the present invention, and are not intended to limit this invention.

### Embodiment 1

This invention provides a numerical establishment method for rebar-concrete interface element, wherein the detailed implementation includes the following steps.
Step 1: Based on an actual condition, a finite element model of reinforced concrete components is established in a finite element software. In the finite element model, main longitudinal rebar and concrete use solid elements with an element type C3D8R, in which the rebar is not required to establish rebar ribs. The rest of rebars use truss elements with an element type of T3D2. The parameters of constitutive models for both rebar and plain concrete are taken in accordance with the Code for the Design of Concrete Structures (GB50010-2010). A discrete model is formed after appropriate meshing, where geometrically contacting rebars are required to co-node with concrete elements. Then, submitting a computational job to generate a solver input file.

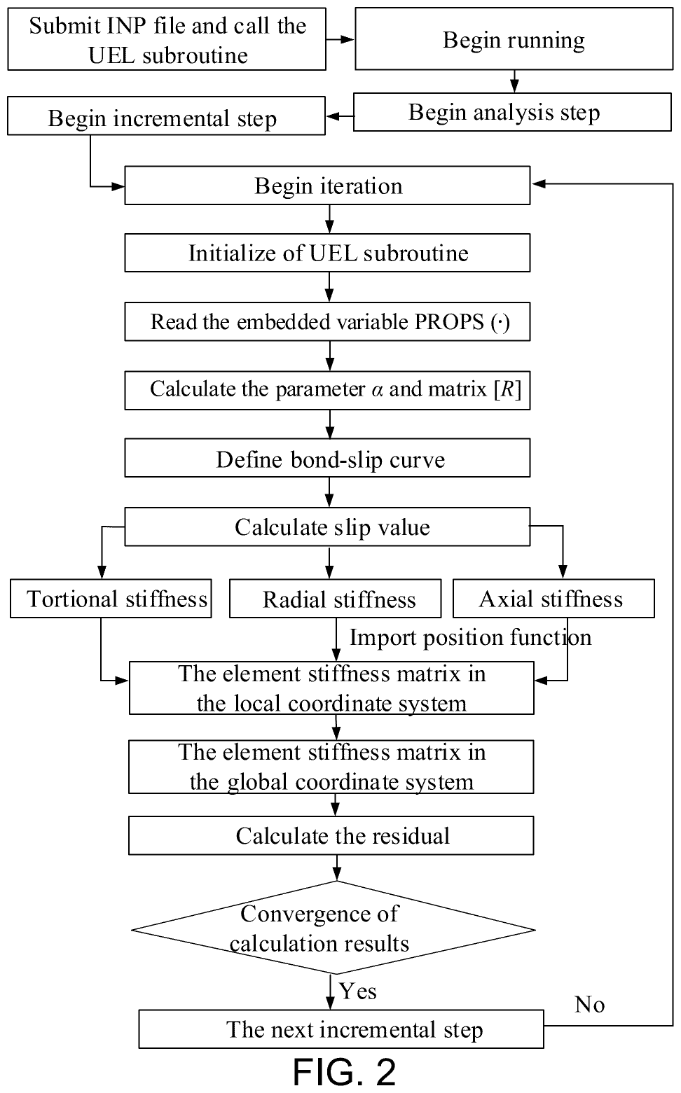

For this embodiment, a center pull-out specimen is established. In addition to satisfying above requirements, specimen information is as follows: a concrete specimen is a cube specimen with a side length of 150 mm, a strength grade of C40, and no fiber incorporated. A diameter of the rebar is 20 mm, type HRB400, and a length of a bond region is 60 mm, i.e., 3 times the diameter of the rebar. Two rows of 6 mm diameter HPB235 stirrups are used with a spacing of 30 mm. Besides, translational degrees of freedom of the concrete at a loading end in a loading direction is constrained.
Step 2: Adding user-defined interface elements to the solver input file and declaring those elements as user-defined elements. The user-defined interface elements are four-node zero-thickness elements with an element type U1001. Further setting number of solution-dependent state variables, as well as numbers and values of element properties, while activating translational degrees of freedom in X, Y, and Z directions. The described user-defined interface element is first set with an element number and then four node numbers in the solver input file, in which node 1 and node 4 are positioned in concrete elements, and node 2 and node 3 are positioned in rebar elements. In this embodiment, a total of 200 user-defined elements are inserted. In particular, in order to facilitate an assignment of material properties to the user-defined elements, a collection of elements named “bond_element” is set up for all user-defined elements to facilitate subsequent definition of input parameters.
Step 3: Based on actual material parameters, inputting characteristic point parameters of an axial bond-slip curve between rebar and concrete, a diameter of rebar, and characteristic parameters of fibers in the user-defined element information of the solver input file. The number of input parameters is 6, which are the diameter of the rebar, fiber characteristics, concrete cubic compressive strength, initial bond stiffness, and coordinates of a midpoint of the rebar in a global coordinate system (values of coordinates in two axes other than the axial direction). In this embodiment, six parameters are 20, 0, 47.53, 46, −66.25, and 60.0. In addition, above parameters will be assigned to a “bond_element” set.
Step 4: A flowchart of an UEL subroutine is shown in FIG. 2, which is focused on setting an element stiffness matrix in a local coordinate system, a coordinate transformation matrix, and a residual of the user-defined interface element.

The element stiffness matrix in the local coordinate system is a 12-order square matrix, which is obtained by assembling stiffness matrices of directions U, V, and W in the local coordinate system by a global coordinate method. Specifically, the stiffness matrix of U direction describes a relationship between axial bond stress and a slip, the stiffness matrix of V direction describes a relationship between a radial stress and the slip, and the stiffness matrix of W direction describes the stiffness of the rebar in torsion direction, as shown in Eqs. (1)-(3).

$$[ {K}_{w} ] = \frac{1}{6} {k}_{w} π dl [ \begin{matrix}2 & - 2 & - 1 & 1 \\ - 2 & 2 & 1 & - 1 \\ - 1 & 1 & 2 & - 2 \\ 1 & - 1 & - 2 & 2\end{matrix} ] \qquad ( 1 )$$

$$[ {K}_{v} ] = \frac{1}{6} {k}_{v} π dl [ \begin{matrix}2 & - 2 & - 1 & 1 \\ - 2 & 2 & 1 & - 1 \\ - 1 & 1 & 2 & - 2 \\ 1 & - 1 & - 2 & 2\end{matrix} ] \qquad ( 2 )$$

$$[ {K}_{u} ] = {k}_{u} π dl [ \begin{matrix}1 & - 1 & 0 & 0 \\ - 1 & 1 & 0 & 0 \\ 0 & 0 & 1 & - 1 \\ 0 & 0 & - 1 & 1\end{matrix} ] \qquad ( 3 )$$

Wherein, [K_{w}], [Kᵥ], and [Kᵤ] represent stiffness matrices of the interface element in axial, radial, and torsional directions in the local coordinate system, respectively; k_{w}, kᵥ, and kᵤ represent stiffnesses of the interface element in axial, radial, and torsional directions in the local coordinate system, respectively; d represents a diameter of rebar; l represents a length of the interface element in a bonding direction.

The relationship between axial bond stress and slip is shown in Eqs. (4)-(7). The stiffness of the rebar in the torsion direction is greater than or equal to 10 MPa.

$$τ = {E}_{b} \cdot s \cdot exp [ - {( \frac{s}{\sqrt[m]{m \cdot {s}_{peak}}} )}^{m} ] \qquad ( 4 )$$

$$m = {[ {ln ( \frac{{τ}_{peak}}{{E}_{b} {s}_{peak}} )}^{- 1} ]}^{- 1} \qquad ( 5 )$$

$${s}_{peak} = ( 1 + \sum {c}_{n} \cdot {λ}_{f , n} ) \times {( \frac{30}{{f}_{cu}} )}^{0.5} \qquad ( 6 )$$

$${τ}_{peak} = ( 1 + \sum {d}_{n} \cdot {λ}_{f , n} ) \times 13.5 {( \frac{{f}_{cu}}{30} )}^{0.5} \qquad ( 7 )$$

Wherein, τ and s represent the axial bond stress and the slip between rebar and concrete, respectively; τₚₑₐₖ and sₚₑₐₖ represent a peak bond stress and corresponding slip, respectively; E_{b} represents the initial bond stiffness; m represents a shape parameter; λ_{f,n} represents the fiber characteristic parameter, which is multiplication of a fiber volume fraction with aspect ratio; dₙ and cₙ represent fiber-enhanced coefficients of the peak bond stress and the corresponding slip, respectively, which can be obtained by fitting to experimental data. Particularly, the equations are applied to plain concrete when n=0, to single fiber reinforced concrete when n=1, and to hybrid fiber reinforced concrete when n≥2; f_{cu} represents a concrete cubic compressive strength.

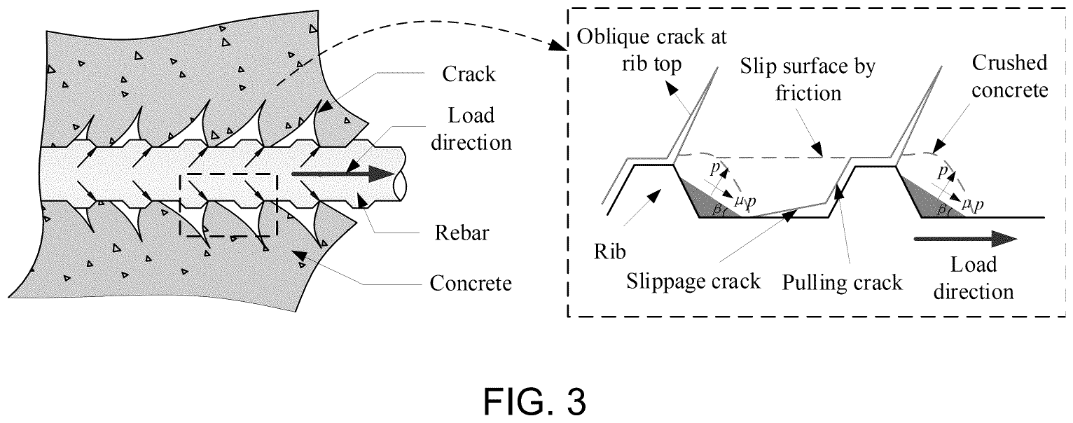

The radial stress and slip curve is established by the following two relationships, which are a relationship between axial bond stress and slip, and a relationship between axial bond stress and radial stress. The relationship between axial bond stress and slip can be obtained according to Eqs. (4)-(7), while the relationship between axial bond stress and radial stress before a peak load can be deduced from a mechanical occlusal force between the rebar and concrete shown in FIG. 3, as shown in Eqs. (8)-(10). After the peak load, as stress of stirrups changes from passive restraint to active release, radial stress does not disappear immediately, but decreases as much as the axial bond stress. For simplicity, it is assumed that a multiplicative relationship between bond stress and radial stress after the peak load shows a decreasing trend.

$$τ = p \cdot sin β + μ \cdot p \cdot cos β \qquad ( 8 )$$

$$q = p \cdot cos β - μ \cdot p \cdot sin β \qquad ( 9 )$$

$$q = \frac{cos β - μ \cdot sin β}{sin β + μ \cdot cos β} \cdot τ \qquad ( 10 )$$

Wherein, q represents the radial stress between rebar and concrete; β represents a slip angle, i.e., an angle between a concrete failure surface and rebar; μ represents a friction coefficient between concrete and rebar.

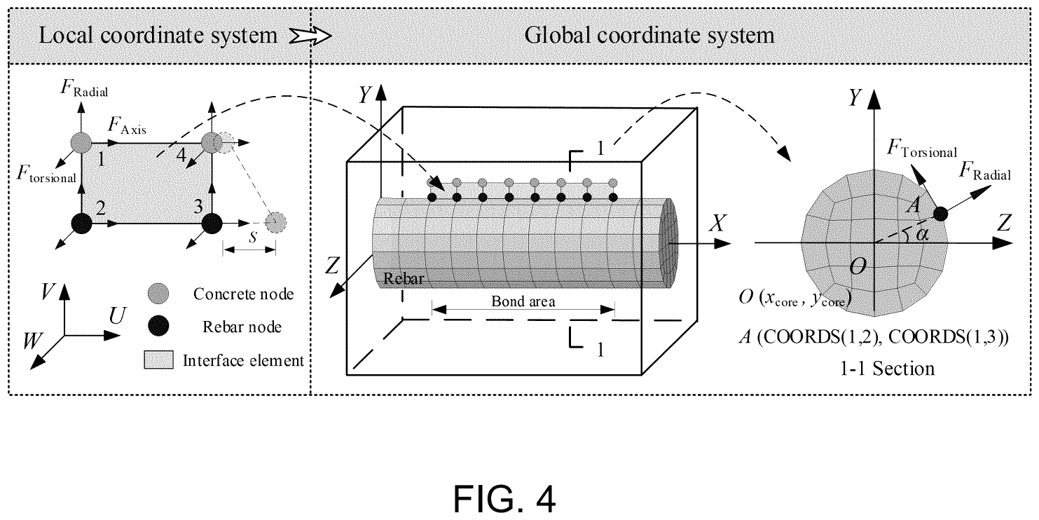

The coordinate transformation matrix is a 12-order square matrix, which enables the element stiffness matrix of the user-defined element in the local coordinate system to be transformed into that in the global coordinate system, and a transformation relationship between them is shown in Eq. (11), while a general sense of the element transformation matrix is shown in Eqs. (12) and (13). In particular, when the interface element does not require a coordinate transformation in the bonding direction of two coordinate systems (as shown in FIG. 4), the coordinate transformation matrix of a node is shown in Eq. (14). The residual is a matrix of 12 rows and 1 column, calculated by subtracting an internal force from an external force, in which the external force is automatically calculated by the finite element software, while the internal force is the element stiffness matrix multiplied by an element displacement matrix in the global coordinate system.

$$[ K ] = {[ R ]}^{T} \cdot [ {K}_{local} ] \cdot [ R ] \qquad ( 11 )$$

$$[ R ] = [ \begin{matrix}{R}_{1} & 0 & 0 & 0 \\ 0 & {R}_{2} & 0 & 0 \\ 0 & 0 & {R}_{3} & 0 \\ 0 & 0 & 0 & {R}_{4}\end{matrix} ] \qquad ( 12 )$$

$$[ {R}_{1} ] = [ {R}_{2} ] = [ {R}_{3} ] = [ {R}_{4} ] = [ \begin{matrix}{U}_{X} & {U}_{Y} & {U}_{Z} \\ {V}_{X} & {V}_{Y} & {V}_{Z} \\ {W}_{X} & {W}_{Y} & {W}_{Z}\end{matrix} ] \qquad ( 13 )$$

$$[ {R}_{1} ] = [ {R}_{2} ] = [ {R}_{3} ] = [ {R}_{4} ] = [ \begin{matrix}sin α & - cos α & 0 \\ cos α & sin α & 0 \\ 0 & 0 & 1\end{matrix} ] \qquad ( 14 )$$

Wherein, [K] represents the element stiffness matrix in the global coordinate system; [K_{local}] represents the element stiffness matrix in the local coordinate system; [R] represents the coordinate transformation matrix; [R₁], [R₂], [R₃], and [R₄] represent the coordinate transformation matrices for nodes 1 to node 4, respectively; U_{X} to W_{Z} represent direction cosines of axes under the local coordinate system of a node to axes under the global coordinate system, respectively; and a meaning of parameter a is shown in FIG. 4.
Step 5: Submitting the solver input file in an ABAQUS software and calling a user subroutine based on step 4. There are two ways to submit the solver input file, i.e., INP file. For one, submitting a calculation job directly in ABAQUS and calling an UEL subroutine. The second is to write a name of the INP file, a name of the UEL subroutine and a number of CPU cores to be invoked in a TXT file according to format requirements. Subsequently, modifying a suffix of the TXT file and saving as a BAT file, then running the BAT file.

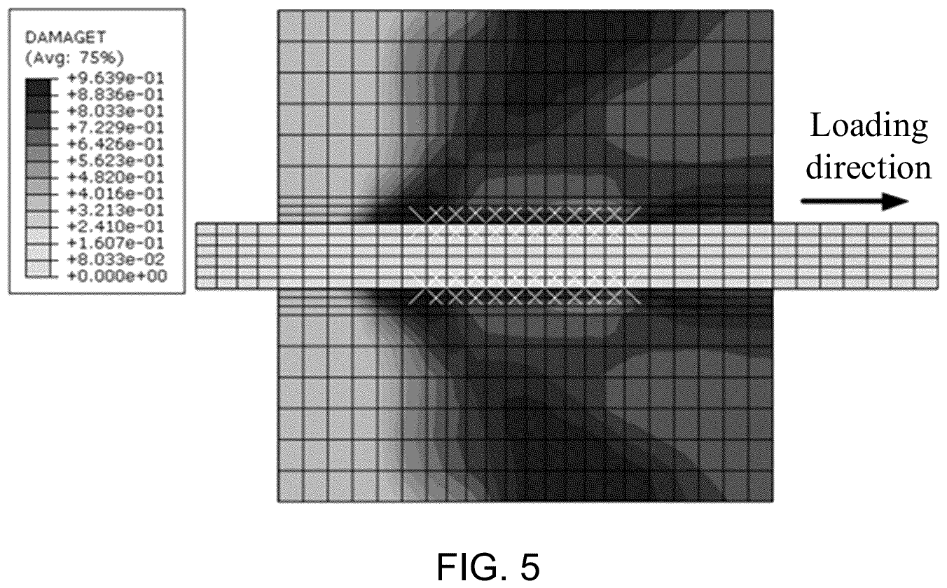

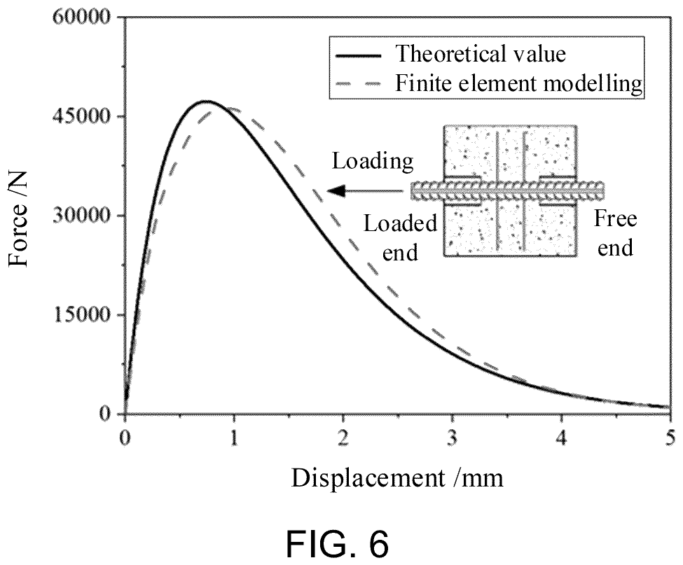

In this embodiment, the first way is used to submit the solver input file. A comparison of a numerical model of the pull-out specimen of the rebar and experimental results is shown in FIGS. 5 and 6. From a tensile damage cloud, it can be concluded that tensile damage (characterizing cracks) is larger at an interface between the rebar and concrete. As the slip continues to increase, free end cracks in a bond region continue to develop obliquely. At the same time, cracks appear on surfaces of the specimen. In a final stage of loading, free end cracks and concrete surface cracks develop in opposite directions and penetrate through, and the pull-out specimen undergoes splitting damage. Comparison between a failure process of finite element results and experimental results shows that the four-node zero-thickness interface element proposed in the present invention can better reflect a failure mode of the pull-out specimen, and better reflect a force-displacement curve.

### Embodiment 2

This invention provides a numerical establishment system for rebar-concrete interface element, comprising:

A module for generating a solver input file: based on an actual condition, a finite element model of a reinforced concrete component is established in a finite element software, whereby a discrete model is formed after being meshed, and for submitting a computational job to generate the solver input file.

A module for inputting user-defined element information: adding user-defined interface elements to the solver input file and entering element numbers and node numbers for the user-defined interface elements, and based on actual material parameters, inputting characteristic point parameters of an axial bond-slip curve between rebar and concrete, a diameter of rebar, and characteristic parameters of fibers in the user-defined element information of the solver input file.

Modules for programming subroutine: setting an element stiffness matrix in a local coordinate system, a coordinate transformation matrix, and a residual of the user-defined interface elements.

Modules for calculating and solving: submitting the solver input file in the finite element software and executing calculations based on the element stiffness matrix in the local coordinate system, the coordinate transformation matrix, and the residual of the modules for programming subroutine.

### Embodiment 3

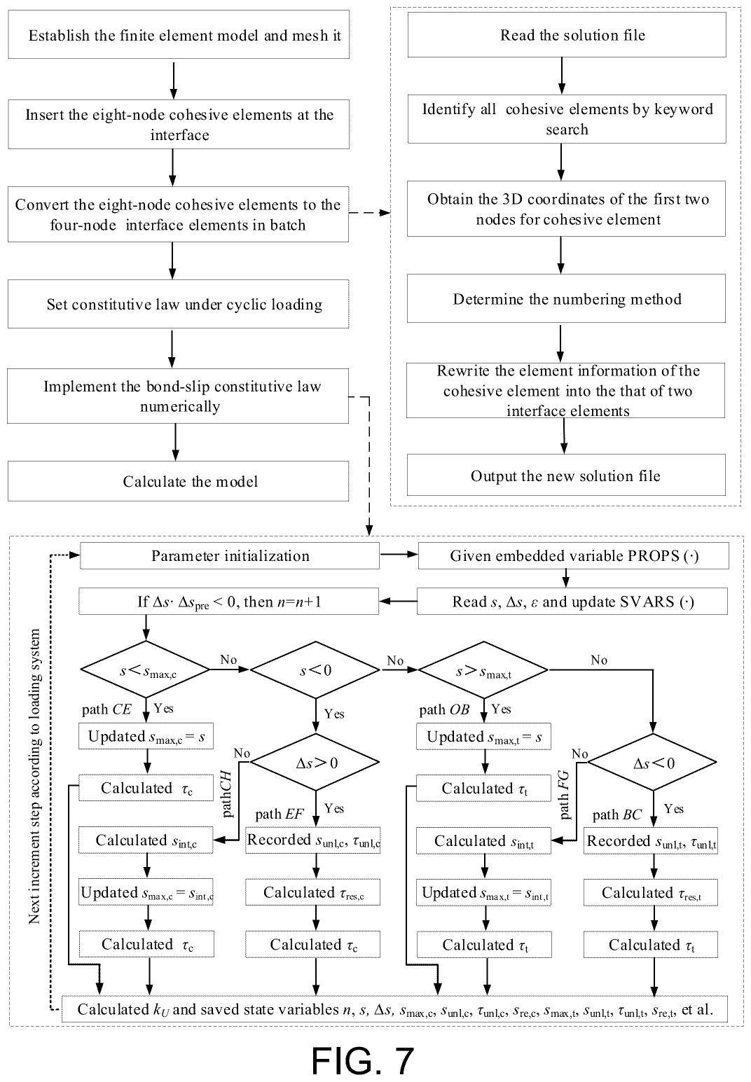

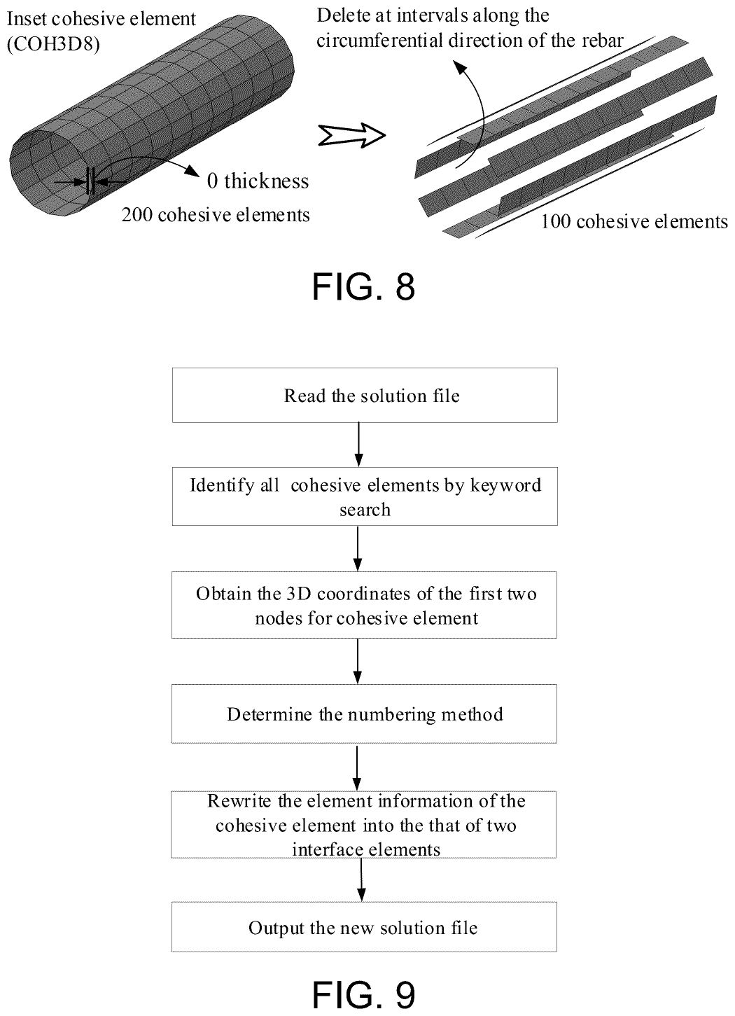

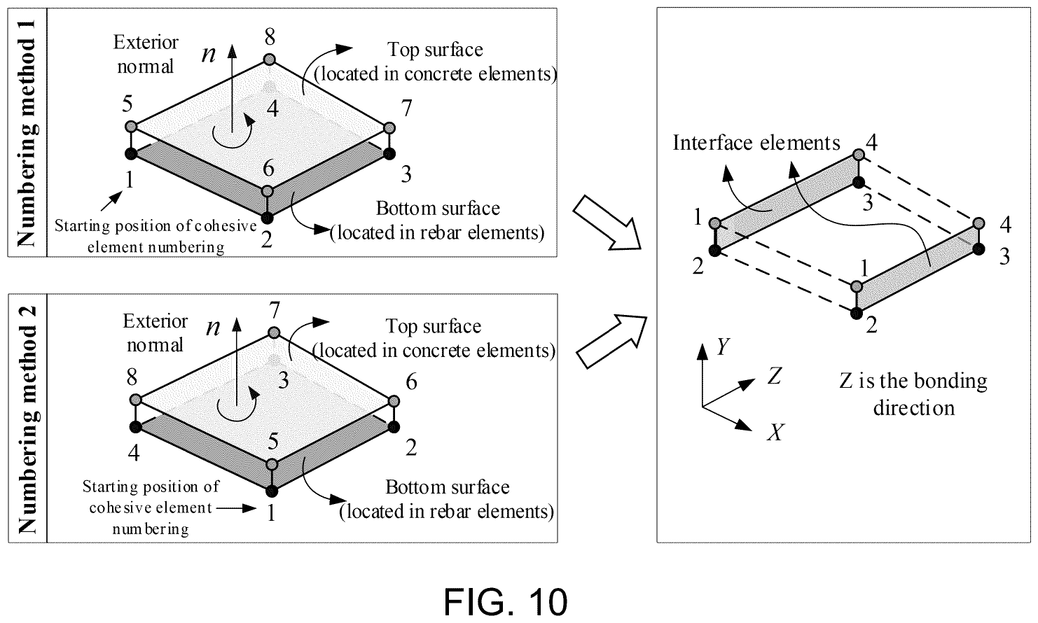

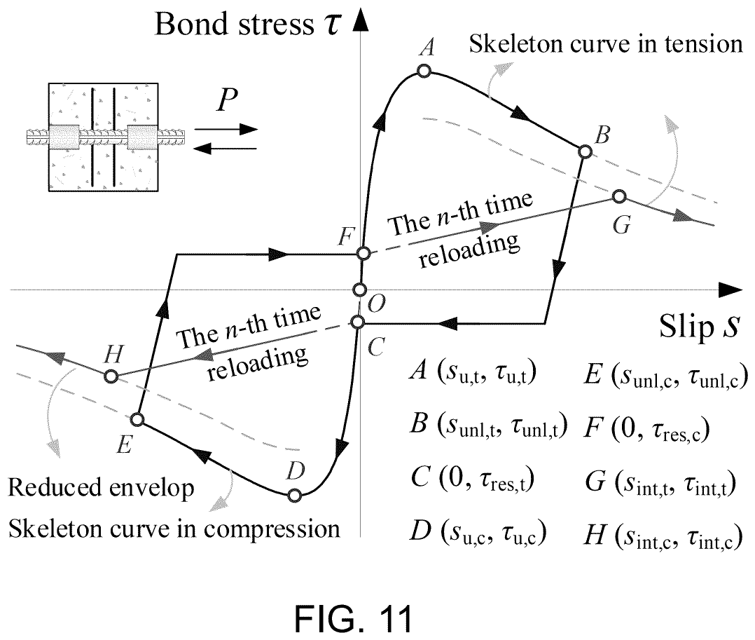

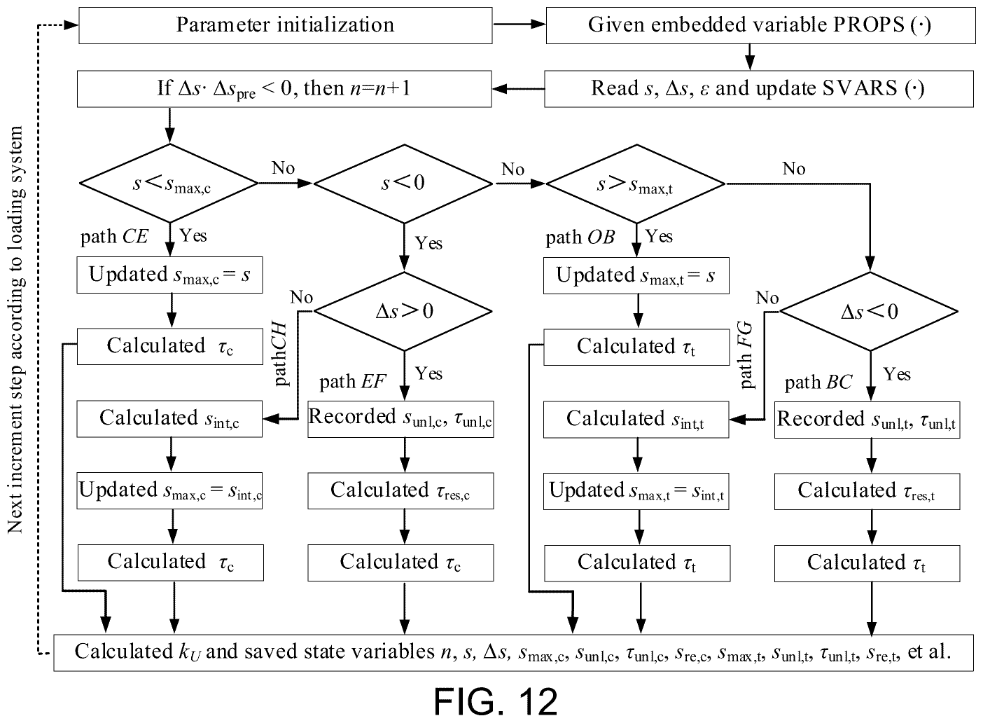

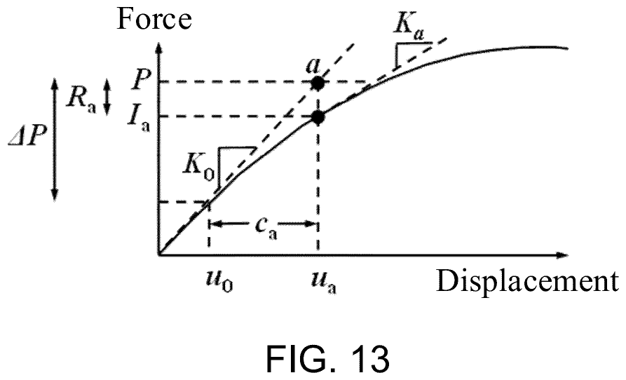

This invention provides a numerical establishment method for rebar-concrete interface element subject to cyclic loading, wherein detailed steps (as shown in FIG. 7) are as follows.
Step S1: modeling a reinforced concrete component in a finite element software and meshing a corresponding model to form a discrete model; inserting a layer of eight-node zero-thickness cohesive elements between rebar and concrete elements, after which the inserted cohesive elements are deleted at intervals along a circumferential direction of the rebar, as shown in FIG. 8. It should be noted that the element deletion is performed because one cohesive element will be converted into two interface elements, and without interval deletion, all interface elements will be duplicated once after a conversion.
Step S2: submitting a computational job to generate a solver input file.
Step S3: reading the solver input file and converting element information of the eight-node zero-thickness cohesive elements to that of four-node zero-thickness user-defined interface elements in batch. Taking FIG. 8 as an example, there are 100 cohesive elements left after batch deletion, and 200 user-defined interface elements will be generated after subsequent batch conversion. Then, setting an element type, a number of nodes, a number of activated degrees of freedom, and material property parameters of the user-defined interface elements, so as to obtain a new solver input file.

Among them, it is to be further noted that an element type is U1001, which sets input parameters and number of variables in a solution process, and activates translational degrees of freedom in the X, Y, and Z directions. The interface element is defined in the INP file by defining first an element number and then four node numbers. Where node 1 and node 4 are positioned in concrete elements and node 2 and node 3 are positioned in rebar elements. Material property parameters are characteristic point parameters in a bond-slip relationship curve between rebar and concrete and part of model geometry parameters.

Specifically, a process of batch conversion (as shown in FIG. 9) is realized through a Python script with following steps.
Step S3.1: reading the solver input file and identifying the element information of all eight-node cohesive elements by keyword search.
Step S3.2: processing the element information of the eight-node cohesive element in turn, while marking element number Eᵢ and first two node numbers (N₁, N₂) for the eight-node cohesive element.
Step S3.3: obtaining 3D coordinates of the first two nodes for the eight-node cohesive element, recorded as (X₁, Y₁, Z₁; X₂, Y₂, Z₂), respectively.
Step S3.4: determining a bonding direction of the rebar; when the bonding direction is in a specific direction, utilizing coordinate values of other two directions for computation; if an absolute value of a square sum of the coordinate values in the other two directions for a node N₁ is subtracted from that for node N₂, subsequently a calculation result is taken as an absolute value; if the calculation result is less than a tolerance, then a cohesive element being processed is a first numbering method, and a step S3.5 is executed; otherwise, the cohesive element being processed is a second numbering method, and a step S3.6 is executed.
The step S3.5: rewriting element information of the cohesive element (E₁, N₁, N₂, N₃, N₄, N₈, N₆, N₇, N₈) into element information of two four-node interface elements (NE₁, N₈, N₁, N₄, N₈) and (NE₂, N₆, N₂, N₃, N₇), then, executing a step S3.7.
the Step S3.6: rewriting the element information of the cohesive element (E₁, N₁, N₂, N₃, N₄, N₈, N₆, N₇, N₈) into element information of two four-node interface elements (NE₁, N₈, N₄, N₃, N₇) and (NE₂, N₈, N₁, N₂, N₆), then, executing the step S3.7.
The step S3.7: checking if there are still cohesive elements in the solver input file. If there are, loop through the steps S3.2 to S3.7 until all cohesive elements are converted into four-node interface elements; if there are none, outputting the new solver input file.
Step S4: a bond-slip constitutive law under cyclic loading described in step S4 emphasizes setting an envelope curve, an unloaded bond stiffness, a bond degradation rate, and a residual bond stress, further comprising:

The envelop curve is set as follows: In view of the fact that a bond damage at the interface between the rebar and surrounding concrete is a continuous process, the bond damage of this process is accumulated one by one and is defined in a way of a damage model in Eq. (15). Considering that an evolution of a damage variable Ω_{y} satisfies a Weibull distribution as shown in Eq. (16), and also considering that a slip value s₀ of 0 mm corresponds to a beginning of the damage, and considering a discounting of bond stress by yielding of the rebar, the bond stress-slip relationship under monotonic loading is shown in Eq. (17). In the Eq. (17), Ω_{y} is a correction coefficient considering an effect of rebar yielding on bond stress, which is calculated as shown in Eq. (18); a and b are both shape parameters of an envelope, which are calculated as shown in Eq. (19). In the Eq. (19), τᵤ and sᵤ are a peak bond stress and a peak slip, respectively, which are calculated as shown in Eqs. (20) and (21), respectively. It should be noted that Eq. (17) is an envelope of the bond-slip constitutive law. Eqs. (15) and (16) are derivation process of Eq. (17). Eq. (18)-Eq. (21) are ways the parameters in Eq. (17) are defined.

$$τ = {E}_{b} \cdot ( 1 - D ) \cdot \qquad ( 15 )$$

$$D = 1 - exp [ - ( s - {s}_{0} ) b / a ] \qquad ( 16 )$$

$$τ = {Ω}_{y} \cdot {E}_{b} \cdot s \cdot exp [ - {( \frac{s}{a} )}^{b} ] \qquad ( 17 )$$

$${Ω}_{y} = \{ \begin{matrix}\begin{matrix}1 & ε \leq {ε}_{y}\end{matrix} \\ 1 - 0.85 \{ 1 - exp [ - 5 {( \frac{ε - {ε}_{y}}{{ε}_{u} - {ε}_{y}} )}^{( 2 - \frac{{f}_{u}}{{f}_{y}} )} ] \} ε > {ε}_{y}\end{matrix} \qquad ( 18 )$$

$${a}^{b} = b \cdot {s}_{u}^{b} , b = - 1 / ln ( {τ}_{u} / {E}_{b} \cdot {s}_{u} ) \qquad ( 19 )$$

$${s}_{u} = ( 1 + {α}_{1} {λ}_{sf} + {β}_{1} {λ}_{pf} ) {( 30 / {f}_{cu} )}^{0.5} \qquad ( 20 )$$

$${τ}_{u} = 13.5 ( 1 + {α}_{2} {λ}_{sf} + {β}_{2} {λ}_{pf} ) {( {f}_{cu} / 30 )}^{0.5} \qquad ( 21 )$$

Wherein, τ and s represent the bond stress and slip, respectively; E_{b} represents an initial bond stiffness; Ω_{y} represents a correction coefficient considering an effect of rebar yielding on bond stress; f_{cu} represents a concrete cubic compressive strength; λ_{sf} and λ_{pf} represent characteristic parameters of steel fiber and polypropylene fiber, respectively; ε_{y} and εᵤ represent a yield strain and ultimate strain of rebar, respectively; f_{y} and fᵤ represent a yield stress and ultimate stress of rebar, respectively; α₁ and α₂ are enhanced coefficients of steel fiber, which can be calibrated according to experimental results or adopt recommended values of 0.76 and 0.20; β₁ and β₂ are enhanced coefficients of polypropylene fiber, which can be calibrated according to experimental result or adopt recommended values of 0.17 and 0.02.

The unloaded bond stiffness E_{ub} is consistent with the initial bond stiffness E_{b}.

The bond degradation rate is set as follows:

$${τ}_{n} / {τ}_{0} = {α}_{3}^{n} \qquad ( 22 )$$

Wherein, τ₀ represents a monotonic bond stress to a certain slip value; τₙ represents a cyclic bond stress of a n-th loading cycle at the same slip; n represents a cycle; α₃ is the bond degradation rate, which can be calibrated from experimental results, or recommended values of 0.97 (before peak slip) and 0.80 (after peak slip) can be adopted.

The residual bond stress is set as follows:

$${τ}_{rev} = {α}_{4} \cdot {τ}_{unl} \qquad ( 23 )$$

Wherein, τᵣₑᵥ represents the residual bond stress; τᵤₙₗ represents a bond stress at a maximum slip before unloading; α₄ represents residual bond stress coefficient, which can be calibrated from experimental results, or recommended values of 0 (before peak slip) and −0.2 (after peak slip) can be adopted.

Step S5: program a user subroutine to numerically implement the bond-slip constitutive law based on step S4. In other words, the bond stress and axial bond stiffness under complex force paths are obtained from current slip values. On this basis, the radial stiffness, axial-radial correlation stiffness, and torsional stiffness of the interface elements are defined, and then values of the stiffness in all directions i.e. axial, radial, axial-radial correlation, and torsion can now be determined. Subsequently, above three values of stiffness, rebar diameter, and length of the interface element in the bonding direction are substituted into the element stiffness matrix (each element stiffness matrix is a 3-row and 3-column matrix) for each of the four directions. The interface elements are further assembled according to a global coordinate method to obtain the element stiffness matrix (12-row and 12-column matrix) in the local coordinate system. The coordinate transformation matrix (12-row, 12-column matrix) and the residuals (12-row and 1-column matrix) of the interface elements are defined in the user subroutine in turn.

In this case, the bond-slip constitutive law under cyclic loading is able to be implemented numerically described in the step S5 by following steps.
Step S5.1: setting an embedded variable PROPS(⋅) to read material property parameters of the user-defined interface elements in the solver input file; calculating a slip value s, a slip increment Δs between the rebar and concrete, and a rebar strain ε; updating values of all state variables SVARS(⋅); calculating a multiplication of the slip increment Δs at a current incremental step and a slip increment Δsₚᵣₑ at a previous incremental step. If a result of the multiplication is less than zero, a number of cycles n is increased by 1, and a step S5.2 is executed; if the result of the multiplication is greater than or equal to zero, the number of cycles n remains unchanged, and a step S5.2 is executed.
the Step S5.2: judging a relationship between the slip value s and a historical maximum slip value s_{max,c} in a compression state. If s<s_{max,c}, then execute a step S5.3, otherwise execute a step S5.4.
the Step S5.3: updating the value of s_{max,c}, i.e., s_{max,c}=s; calculating the bond stress r; and executing a step S5.13.
the Step S5.4: judging a relationship between the slip value s and 0. If s<0, execute a step S5.5, otherwise execute a step S5.8.
the Step S5.5: judging a relationship between the slip increment Δs and 0. If Δs>0, execute a step S5.6, otherwise execute a step S5.7.
the Step S5.6: recording a bond stress τ_{unl,c} and a slip value s_{unl,c} at an unloading point in the compression state, i.e., τ_{unl,c}=τ and s_{unl,c}=s; calculating a residual bond stress τ_{res,c} in the compression state; calculating the bond stress τ=τ_{unl,c}+E_{ub}·Δs, wherein E_{ub} is an unloading stiffness; judging when τ>τ_{unl,c}, then making τ=τ_{unl,c}; and executing the step S5.13.
the Step S5.7: calculating a bond stress τ_{int,c} and a corresponding slip s_{int,c} at an intersection of a reloading curve and a reduced envelope curve in the compression state; updating a value of s_{max,c}, i.e., s_{max,c}=s; calculating the bond stress τ; and executing the step S5.13.
the Step S5.8: judging a relationship between the slip value s and a historical maximum slip value s_{max,t} in a tension state. If s>s_{max,t}, then execute a step S5.9, otherwise execute a step S5.10.
the Step S5.9: updating the value of s_{max,t}, i.e., s_{max,t}=s; calculating the bond stress r; and executing the step S5.13.
the Step S5.10: judging a relationship between the slip increment Δs and 0. If Δs<0, execute a step S5.11, otherwise execute a step S5.12.
the Step S5.11: recording a bond stress τ_{unl,t} and a slip value s_{unl,t} at the unloading point in the compression state, i.e., τ_{unl,t}=τ and s_{unl,t}=s; calculating a residual bond stress τ_{res,t} in the compression state; calculating the bond stress τ=τ_{unl,c}+E_{ub}·Δs, wherein E_{ub} is the unloading stiffness; judging when τ<τ_{unl,t}, then making τ=τ_{unl,t}; and executing the step S5.13.
the Step S5.12: calculating a bond stress τ_{int,t} and a corresponding slip s_{int,t} at the intersection of the reloading curve and the reduced envelope curve in the tension state; updating the value of s_{max,t}, i.e., s_{max,t}=s; calculating the bond stress τ; and executing the Step S5.13.
the Step S5.13: calculating axial bond stiffness k_{U}=τ/s; saving all state variables SVARS(⋅); assembling the element stiffness matrix based on the axial, radial, torsional direction, and axial-radial correlation stiffness matrices of the user-defined interface element; setting the coordinate transformation matrix to transform the element stiffness matrix in the local coordinate system to the global coordinate system; calculating the residuals; and proceeding to a next incremental step and executing the step S5.1.

Among the steps, the bond stress τ_{int,c} and the corresponding slip s_{int,c} at the intersection of the reloading curve and the reduced envelope curve in the compression state, as well as the bond stress τ_{int,t} and the corresponding slip s_{int,t} at the intersection of the reloading curve and the reduced envelope curve in the tension state are obtained as follows

Initially, the reloading stiffness is calculated from the bond stress and the corresponding slip at an initial reloading point, a slip at the maximum unloading point, and the bond degradation rate, subsequently, since the bond stress and slip at the initial reloading point, the reduced envelope curve, and the reloading stiffness are known, the bond stress and the corresponding slip at the intersection of the reloading curve and the reduced envelope curve are obtained through a method of the dichotomy when the error is less than a set threshold.
Step S6: submitting the new solver input file from step S3 in the finite element software and executing calculations based on the user subroutine in the step S5.

In order to make the purpose, technical solutions and advantages of the embodiments of the present invention clearer, the following examples are conducted at the material and component levels, respectively.

### Embodiment 4

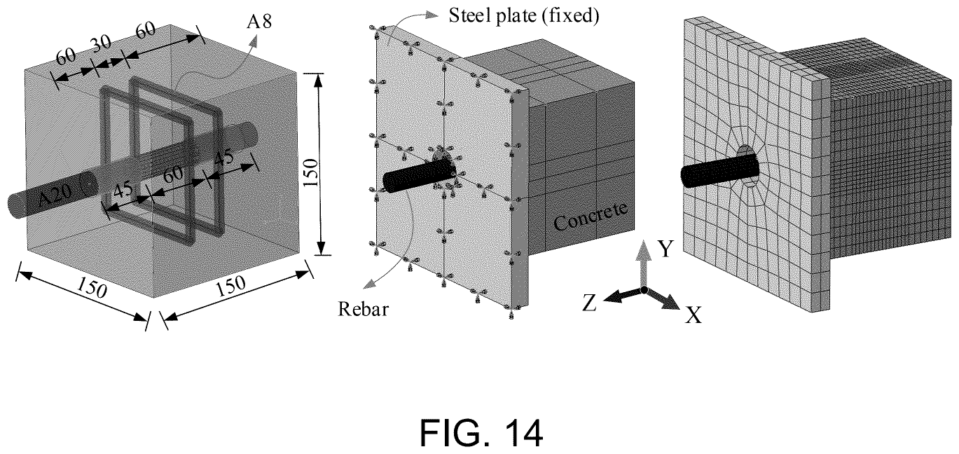

For this embodiment, a center pull-out specimen is established. A concrete specimen is a cube specimen with a side length of 150 mm. The cubic compressive strength is 50.93 MPa. Volume fraction and aspect ratio of steel fiber are 1.0% and 60, respectively, and the fraction and aspect ratio of polypropylene fiber are 0.15% and 167, respectively. The diameter of the rebar is 20 mm, type HRB400, and the length of the bond region is 60 mm, i.e., 3 times the diameter of the rebar. Two rows of 6 mm diameter HPB235 stirrups are used with a spacing of 30 mm. Besides, the translational degree of freedom of the concrete at the loading end in the loading direction is constrained, as shown in FIG. 14.

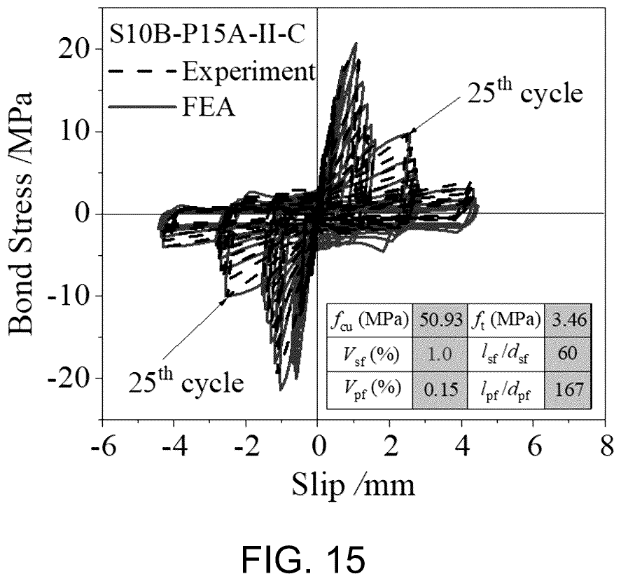

As shown in FIG. 15, the bond-slip curve under cyclic loading is in good agreement with the experiment, which indicates that the interface element in the present invention can well reflect a mechanical response of the pull-out specimen under cyclic loading.

### Embodiment 5

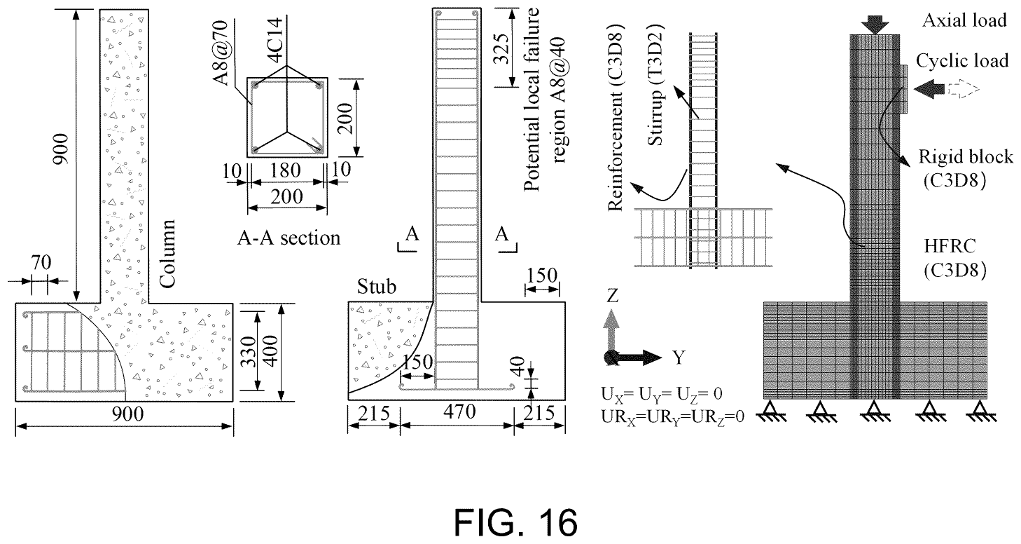

In order to verify effects of the interface element of the present invention on the mechanical response of reinforced concrete components under cyclic loading, a comparison is made with experimental data of a steel-polypropylene hybrid fiber-reinforced concrete column. The specimen consisted of a column with dimensions of 800×200×200 mm and a base with dimensions of 900×400×400 mm. A shear-to-span ratio is 4 and an axial compression ratio is 0.308. The concrete strength, steel fiber characteristic parameters, and polypropylene fiber characteristic parameters are 56.1 MPa, 0.968, and 0.594, respectively. The detailed reinforcement diagram and numerical model of the column are shown in FIG. 16.

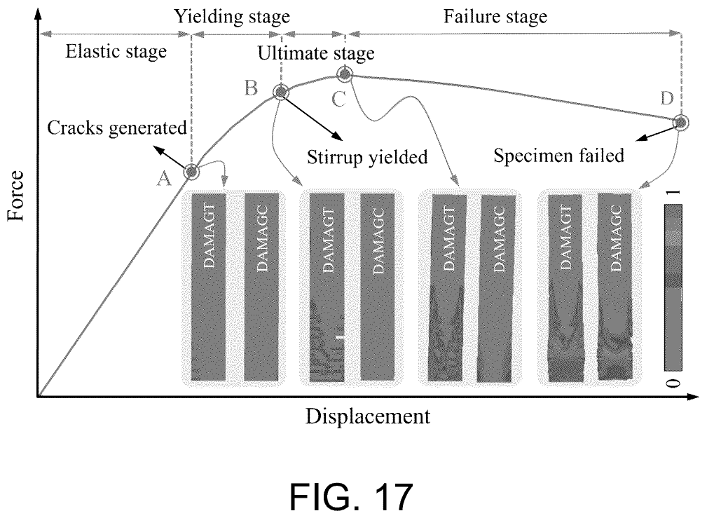

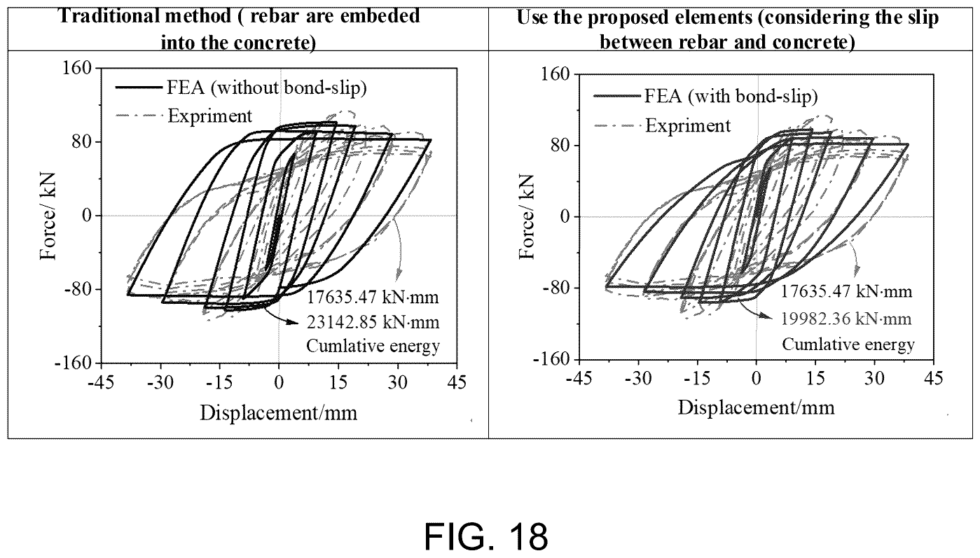

The failure process of numerical simulation of the reinforced concrete column is shown in FIG. 17, which presents a diagonal shear failure pattern and matches experimental results. A hysteresis curve is shown in FIG. 18, which shows that an energy dissipation capacity of the reinforced concrete column under cyclic loading can be better reflected by using the interface element proposed in the present invention.

### Embodiment 6

This invention provides a numerical establishment system for rebar-concrete interface element subjected to cyclic loading, wherein the detailed implementation includes the following modules:

A module for modeling: modeling a reinforced concrete component in a finite element software and meshing it to form a discrete model. Then, inserting a layer of eight-node zero-thickness cohesive elements between rebar and concrete elements, after which the cohesive elements are deleted at intervals along a circumferential direction of the rebar.

A module for generating a solver input file: submitting a computational job to generate the solver input file.

A module for updating the solver input file: reading the solver input file and converting element information of the eight-node zero-thickness cohesive elements to that of the four-node zero-thickness user-defined interface elements in batch. Then, setting the element type, number of nodes, number of activated degrees of freedom, and material property parameters of the user-defined interface elements, so as to obtain a new solver input file.

Modules for setting constitutive law: setting a bond-slip constitutive law under cyclic loading.

Modules for programming subroutine: program a user subroutine to numerically implement the bond-slip constitutive law based on the modules for setting constitutive law.

Modules for calculating and solving: submitting the new solver input file from the module for updating the solver input file in the finite element software and executing calculations based on the modules for programming subroutine.

The method of the present invention could be executed by an electronic equipment in practical implementations, wherein the electronic equipment comprises:
(1) Processor: the processor may be a central processing unit (CPU) or other forms of processing units (such as a graphics processing unit, GPU) capable of data processing and instruction execution, and may control other components in the above-mentioned electronic devices to perform desired functions.
(2) Memory: the memory may include one or more computer program products, which may include various forms of computer-readable storage media, such as volatile memory and/or non-volatile memory.

It should be understood that the above-mentioned descriptions for the preferred embodiments are relatively detailed, and should not be considered as limiting the scope of the patent protection of the present invention. Within the scope of protection, replacements or modifications can also be made, all of which fall within the protection scope of the present invention, and the scope of protection of the present invention should be based on the appended claims.

It should be understood that the parts not described in detail in this specification belong to the prior art.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A numerical establishment method for rebar-concrete interface element, comprising a plurality of steps:
Step 1: establishing a finite element model of a reinforced concrete component in a finite element software based on actual conditions and forming a discrete model after meshing the finite element model, and submitting a computational job to generate a solver input file;
Step 2: adding user-defined interface elements to the solver input file and entering element numbers and node numbers for the user-defined interface elements;
Step 3: based on actual material parameters, inputting characteristic point parameters of an axial bond-slip curve, a diameter of rebar, and characteristic parameters of fibers in user-defined element information of the solver input file;
Step 4: setting an element stiffness matrix in a local coordinate system, a coordinate transformation matrix, and a residual of the user-defined interface elements;
Step 5: submitting the solver input file in the finite element software and executing calculations based on the step 4.

2. The numerical establishment method for rebar-concrete interface element according to claim 1, further comprising: when establishing the finite element model described in the step 1, solid elements are utilized for both longitudinal rebar and concrete, whereas truss elements are utilized for remaining rebars; and longitudinal rebar elements of the discrete model are co-noded with concrete elements.

3. The numerical establishment method for rebar-concrete interface element according to claim 1, wherein the user-defined interface elements of the step 2 are four-node zero-thickness elements, the numerical establishment method further comprises:
setting a number of solution-dependent state variables and numbers and values of element properties, while also activating translational degrees of freedom in X, Y, and Z directions;
the user-defined interface elements are initially assigned an element number and then four node numbers in the solver input file, upon which node 1 and node 4 are positioned in the concrete elements, and node 2 and node 3 are positioned in rebar elements.

4. The numerical establishment method for rebar-concrete interface element according to claim 3, further comprising: the numbers of the element properties are set as required, including the diameter of the rebar, fiber characteristic parameters, concrete cubic compressive strength, initial bond stiffness, and coordinates of two other directions except an axial direction for a midpoint of a rebar section in a global coordinate system.

5. The numerical establishment method for rebar-concrete interface element according to claim 1, further comprising: the element stiffness matrix described in the step 4 is a 12-order square matrix, including stiffnesses of the user-defined interface elements in U, V, and W directions in the local coordinate system;
the coordinate transformation matrix is a 12-order square matrix, facilitating transformation of the element stiffness matrix from the local coordinate system to the global coordinate system for the user-defined interface elements;
the residual is a matrix of 12 rows and 1 column, calculated by subtracting an internal force from an external force, in which the external force is automatically calculated by the finite element software, while the internal force is the element stiffness matrix multiplied by an element displacement matrix in the global coordinate system.

6. The numerical establishment method for rebar-concrete interface element according to claim 5, further comprising: a transformation relationship between the element stiffness matrix in the local coordinate system and that in the global coordinate system is presented in Eq. (11), and the coordinate transformation matrixes are shown in Eqs. (12) and (13);
$$[ K ] = {[ R ]}^{T} \cdot [ {K}_{local} ] \cdot [ R ] \qquad ( 11 )$$
$$[ R ] = [ \begin{matrix}{R}_{1} & 0 & 0 & 0 \\ 0 & {R}_{2} & 0 & 0 \\ 0 & 0 & {R}_{3} & 0 \\ 0 & 0 & 0 & {R}_{4}\end{matrix} ] \qquad ( 12 )$$
$$[ {R}_{1} ] = [ {R}_{2} ] = [ {R}_{3} ] = [ {R}_{4} ] = [ \begin{matrix}{U}_{X} & {U}_{Y} & {U}_{Z} \\ {V}_{X} & {V}_{Y} & {V}_{Z} \\ {W}_{X} & {W}_{Y} & {W}_{Z}\end{matrix} ] \qquad ( 13 )$$
wherein, [K] represents the element stiffness matrix in the global coordinate system; [K_{local}] represents the element stiffness matrix in the local coordinate system; [R] represents the coordinate transformation matrix, [R₁], [R₂], [R₃], and [R₄] represent the coordinate transformation matrices for the node 1 to the node 4, respectively; and U_{X} to W_{Z} represent direction cosines of axes in the local coordinate system to axes in the global coordinate system, respectively.

7. The numerical establishment method for rebar-concrete interface element according to claim 5, further comprising: the element stiffness matrix in the local coordinate system is obtained by assembling stiffness matrices of U, V, and W directions in the local coordinate system by the global coordinate method, in which the stiffness matrix of U direction describes the relationship between axial bond stress and a slip, the stiffness matrix of V direction describes the relationship between a radial stress and the slip, and the stiffness matrix of W direction describes stiffness of a rebar in torsion direction, as shown in Eqs. (1)-(3),
$$[ {K}_{w} ] = \frac{1}{6} {k}_{w} π dl [ \begin{matrix}2 & - 2 & - 1 & 1 \\ - 2 & 2 & 1 & - 1 \\ - 1 & 1 & 2 & - 2 \\ 1 & - 1 & - 2 & 2\end{matrix} ] \qquad ( 1 )$$
$$[ {K}_{v} ] = \frac{1}{6} {k}_{v} π dl [ \begin{matrix}2 & - 2 & - 1 & 1 \\ - 2 & 2 & 1 & - 1 \\ - 1 & 1 & 2 & - 2 \\ 1 & - 1 & - 2 & 2\end{matrix} ] \qquad ( 2 )$$
$$[ {K}_{u} ] = {k}_{u} π dl [ \begin{matrix}1 & - 1 & 0 & 0 \\ - 1 & 1 & 0 & 0 \\ 0 & 0 & 1 & - 1 \\ 0 & 0 & - 1 & 1\end{matrix} ] \qquad ( 3 )$$
wherein, [K_{w}], [Kᵥ], and [Kᵤ] represent the stiffness matrices of the interface element in axial, radial, and torsional directions in the local coordinate system, respectively; k_{w}, kᵥ, and kᵤ represent stiffness of the user-defined interface elements in axial, radial, and torsional directions in the local coordinate system, respectively; d represents the diameter of rebar; l represents a length of the user-defined interface elements in a bonding direction.

8. The numerical establishment method for rebar-concrete interface element according to claim 7, further comprising: a relationship between the axial bond stress and the slip is shown in Eqs. (4)-(7), a relationship between the axial bond stress and radial stress is shown in Eq. (10), and the stiffness of the rebar in the torsion direction is greater than or equal to 105 MPa,
$$τ = {E}_{b} \cdot s \cdot exp [ - {( \frac{s}{\sqrt[m]{m \cdot {s}_{peak}}} )}^{m} ] \qquad ( 4 )$$
$$m = {[ {ln ( \frac{{τ}_{peak}}{{E}_{b} {s}_{peak}} )}^{- 1} ]}^{- 1} \qquad ( 5 )$$
$${s}_{peak} = ( 1 + \sum {c}_{n} \cdot {λ}_{f , n} ) \times {( \frac{30}{{f}_{cu}} )}^{0.5} \qquad ( 6 )$$
$${τ}_{peak} = ( 1 + \sum {d}_{n} \cdot {λ}_{f , n} ) \times 13.5 {( \frac{{f}_{cu}}{30} )}^{0.5} \qquad ( 7 )$$
$$q = \frac{cos β - μ \cdot sin β}{sin β + μ \cdot cos β} \cdot τ \qquad ( 10 )$$
wherein, τ and s represent the axial bond stress and the slip between rebar and concrete, respectively; τₚₑₐₖ and sₚₑₐₖ represent a peak bond stress and corresponding slip, respectively; E_{b} represents the initial bond stiffness; m represents a shape parameter; λ_{f,n} represents the fiber characteristic parameter, which is multiplication of a fiber volume fraction with aspect ratio; dₙ and cₙ represent fiber-enhanced coefficients of the peak bond stress and the corresponding slip, respectively, which can be obtained by fitting to experimental data; particularly, the equations are applied to plain concrete when n=0, to single fiber reinforced concrete when n=1, and to hybrid fiber reinforced concrete when n≥2; f_{cu} represents a concrete cubic compressive strength; q represents a radial stress between rebar and concrete; β represents a slip angle, i.e., an angle between a concrete failure surface and the rebar; μ represents a friction coefficient between concrete and rebar.

9. A numerical establishment system for rebar-concrete interface element, comprising:
a module for generating a solver input file: based on an actual condition, a finite element model of a reinforced concrete component is established in a finite element software, whereby a discrete model is formed after being meshed, and for submitting a computational job to generate the solver input file;
a module for inputting user-defined element information: adding user-defined interface elements to the solver input file and entering element numbers and node numbers for the user-defined interface elements, and based on actual material parameters, inputting characteristic point parameters of an axial bond-slip curve between rebar and concrete, a diameter of rebar, and characteristic parameters of fibers in the user-defined element information of the solver input file;
modules for programming subroutine: setting an element stiffness matrix in a local coordinate system, a coordinate transformation matrix, and a residual of the user-defined interface elements;
modules for calculating and solving: submitting the solver input file in the finite element software and executing calculations based on the element stiffness matrix in the local coordinate system, the coordinate transformation matrix, and the residual of the modules for programming subroutine, wherein the described numerical establishment system for rebar-concrete interface element is used to perform the steps in the numerical establishment method for rebar-concrete interface element as claimed in any one of claim 1.

10. A numerical establishment method for rebar-concrete interface element subject to cyclic loading, comprising a plurality of steps as follows:
Step S1: modeling a reinforced concrete component in a finite element software and meshing a corresponding model to form a discrete model; inserting a layer of eight-node zero-thickness cohesive elements between rebar and concrete elements, after which the inserted cohesive elements are deleted at intervals along a circumferential direction of the rebar;
Step S2: submitting a computational job to generate a solver input file;
Step S3: reading the solver input file and converting element information of the eight-node zero-thickness cohesive elements to that of four-node zero-thickness user-defined interface elements in batch; setting an element type, a number of nodes, a number of activated degrees of freedom, and material property parameters of user-defined interface elements, so as to obtain a new solver input file;
Step S4: setting a bond-slip constitutive law under cyclic loading;
Step S5: programing a user subroutine to numerically implement the bond-slip constitutive law based on the step S4;
Step S6: submitting the new solver input file from the step S3 in the finite element software and executing calculations based on the user subroutine in the step S5.

11. The numerical establishment method for rebar-concrete interface element subjected to cyclic loading according to claim 10, wherein a batch conversion process for element information from eight-node cohesive elements to four-node interface elements in the step S3 is as follows:
Step S3.1: reading the solver input file and identifying the element information of all eight-node cohesive elements by keyword search;
Step S3.2: processing the element information of the eight-node cohesive element in turn, while marking element number E₁ and first two node numbers (N₁, N₂) for the eight-node cohesive element;
Step S3.3: obtaining 3D coordinates of the first two nodes for the eight-node cohesive element, recorded as (X₁, Y₁, Z₁; X₂, Y₂, Z₂), respectively;
Step S3.4: determining a bonding direction of the rebar; when the bonding direction is in a specific direction, utilizing coordinate values of other two directions for computation; if an absolute value of a square sum of the coordinate values in the other two directions for a node N₁ is subtracted from that for node N₂, subsequently a calculation result is taken as an absolute value; if the calculation result is less than a tolerance, then a cohesive element being processed is a first numbering method, and a step S3.5 is executed; otherwise, the cohesive element being processed is a second numbering method, and a step S3.6 is executed;
the Step S3.5: rewriting element information of the cohesive element (E₁, N₁, N₂, N₃, N₄, N₈, N₆, N₇, N₈) into element information of two four-node interface elements (NE₁, N₈, N₁, N₄, N₈) and (NE₂, N₆, N₂, N₃, N₇), then, executing a step S3.7;
the Step S3.6: rewriting the element information of the cohesive element (E₁, N₁, N₂, N₃, N₄, N₈, N₆, N₇, N₈) into element information of two four-node interface elements (NE₁, N₈, N₄, N₃, N₇) and (NE₂, N₈, N₁, N₂, N₆), then, executing the step S3.7;
the Step S3.7: checking if there are still cohesive elements in the solver input file, if there are, loop through the steps S3.2 to S3.7 until all cohesive elements are converted into four-node interface elements; if there are none, outputting the new solver input file.

12. The numerical establishment method for rebar-concrete interface element subjected to cyclic loading according to claim 10, wherein the bond-slip constitutive law of the step S4 under cyclic loading comprises setting an envelope curve, an unloaded bond stiffness, a bond degradation rate, and a residual bond stress,
the envelop curve of the step S4 is set as follows:
$$τ = {Ω}_{y} \cdot {E}_{b} \cdot s \cdot exp [ - {( \frac{s}{a} )}^{b} ] \qquad ( 15 )$$
the unloaded bond stiffness E_{ub} is consistent with an initial bond stiffness E_{b};
the bond degradation rate is set as follows:
$${α}_{3}^{n} = {τ}_{n} / {τ}_{0} \qquad ( 22 )$$
the residual bond stress is set as follows:
$${τ}_{rev} = {α}_{4} \cdot {τ}_{unl} \qquad ( 23 )$$
wherein, τ and s represent bond stress and slip, respectively; E_{b} represents the initial bond stiffness; Ω_{y} represents a correction coefficient considering an effect of rebar yielding on bond stress; a and b represent parameters that control a shape of the envelop curve; α₃ represents a bond degradation coefficient; τ₀ represents a monotonic bond stress to a certain slip value; τₙ represents a cyclic bond stress of a n-th loading cycle at the same slip; n represents a cycle; τᵣₑᵥ represents the residual bond stress; τᵤₙₗ is a bond stress at a maximum slip before unloading; α₄ represents a residual bond stress coefficient.

13. The numerical establishment method for rebar-concrete interface element subjected to cyclic loading according to claim 12, wherein the correction coefficient Ω_{y} considering the effect of rebar yielding on bond stress is set as follows:
$${Ω}_{y} = \{ \begin{matrix}\begin{matrix}1 & ε \leq {ε}_{y}\end{matrix} \\ 1 - 0.85 \{ 1 - exp [ - 5 {( \frac{ε - {ε}_{y}}{{ε}_{u} - {ε}_{y}} )}^{( 2 - \frac{{f}_{u}}{{f}_{y}} )} ] \} ε > {ε}_{y}\end{matrix} \qquad ( 18 )$$
wherein, ε represents a strain of rebar; ε_{y} and εᵤ represent a yield strain and ultimate strain of rebar, respectively; f_{y} and fᵤ represent a yield stress and ultimate stress of rebar, respectively.

14. The numerical establishment method for rebar-concrete interface element subjected to cyclic loading according to claim 12, wherein the shape parameters of envelop curve are obtained by the following equation:
$${a}^{b} = b \cdot {s}_{u}^{b} , b = - 1 / ln ( {τ}_{u} / {E}_{b} \cdot {s}_{u} ) \qquad ( 19 )$$
wherein, τᵤ and sᵤ represent a peak bond stress and corresponding slip.

15. The numerical establishment method for rebar-concrete interface element subjected to cyclic loading according to claim 10, wherein the bond-slip constitutive law under cyclic loading is implemented numerically described in the step S5 by the following steps:
Step S5.1: setting an embedded variable PROPS(⋅) to read material property parameters of the user-defined interface elements in the solver input file; calculating a slip value s, a slip increment Δs between the rebar and concrete, and a rebar strain ε; updating values of all state variables SVARS(⋅); calculating a multiplication of the slip increment Δs at a current incremental step and a slip increment Δsₚᵣₑ at a previous incremental step, if a result of the multiplication is less than zero, a number of cycles n is increased by 1, and a step S5.2 is executed; if the result of the multiplication is greater than or equal to zero, the number of cycles n remains unchanged, and a step S5.2 is executed;
the Step S5.2: judging a relationship between the slip value s and a historical maximum slip value s_{max,c} in a compression state, if s<s_{max,c}, then execute a step S5.3, otherwise execute a step S5.4;
the Step S5.3: updating the value of s_{max,c}, i.e., s_{max,c}=s; calculating the bond stress τ; and executing a step S5.13;
the Step S5.4: judging a relationship between the slip value s and 0, if s<0, execute a step S5.5, otherwise execute a step S5.8;
the Step S5.5: judging a relationship between the slip increment Δs and 0, if Δs>0, execute a step S5.6, otherwise execute a step S5.7;
the Step S5.6: recording a bond stress τ_{unl,c} and a slip value s_{unl,c} at an unloading point in the compression state, i.e., τ_{unl,c}=τ and s_{unl,c}=s; calculating a residual bond stress τ_{res,c} in the compression state; calculating the bond stress τ=τ_{unl,c}+E_{ub}·Δs, wherein E_{ub} is an unloading stiffness; judging when τ>τ_{unl,c}, then making τ=τ_{unl,c}; and executing the step S5.13;
the Step S5.7: calculating a bond stress τ_{int,c} and a corresponding slip s_{int,c} at an intersection of a reloading curve and a reduced envelope curve in the compression state; updating a value of s_{max,c}, i.e., s_{max,c}=s; calculating the bond stress τ; and executing the step S5.13;
the Step S5.8: judging a relationship between the slip value s and a historical maximum slip value s_{max,t} in a tension state, if s>s_{max,t}, then execute a step S5.9, otherwise execute a step S5.10;
the Step S5.9: updating the value of s_{max,t}, i.e., s_{max,t}=s; calculating the bond stress τ; and
executing the step S5.13;
the Step S5.10: judging a relationship between the slip increment Δs and 0, if Δs<0, execute a step S5.11, otherwise execute a step S5.12;
the Step S5.11: recording a bond stress τ_{unl,t} and a slip value s_{unl,t} at the unloading point in the compression state, i.e., τ_{unl,t}=τ and s_{unl,t}=s; calculating a residual bond stress τ_{res,t} in the compression state; calculating the bond stress τ=τ_{unl,c}+E_{ub}−Δs, wherein E_{ub} is the unloading stiffness; judging when τ<τ_{unl,t}, then making τ=τ_{unl,t}; and executing the step S5.13;
the Step S5.12: calculating a bond stress τ_{int,t} and a corresponding slip s_{int,t} at the intersection of the reloading curve and the reduced envelope curve in the tension state; updating the value of s_{max,t}, i.e., s_{max,t}=s; calculating the bond stress τ; and executing the Step S5.13;
the Step S5.13: calculating axial bond stiffness k_{U}=τ/s; saving all state variables SVARS(⋅); assembling the element stiffness matrix based on the axial, radial, torsional direction, and axial-radial correlation stiffness matrices of the user-defined interface element; setting the coordinate transformation matrix to transform the element stiffness matrix in the local coordinate system to the global coordinate system; calculating the residuals; and proceeding to a next incremental step and executing the step S5.1.

16. The numerical establishment method for rebar-concrete interface element subjected to cyclic loading according to claim 15, further comprising:
the bond stress τ_{int,c} and the corresponding slip s_{int,c} at the intersection of the reloading curve and the reduced envelope curve in the compression state, as well as the bond stress τ_{int,t} and the corresponding slip s_{int,t} at the intersection of the reloading curve and the reduced envelope curve in the tension state are obtained as follows:
initially, the reloading stiffness is calculated from the bond stress and the corresponding slip at an initial reloading point, a slip at the maximum unloading point, and the bond degradation rate, subsequently, since the bond stress and slip at the initial reloading point, the reduced envelope curve, and the reloading stiffness are known, the bond stress and the corresponding slip at the intersection of the reloading curve and the reduced envelope curve are obtained through a method of the dichotomy when the error is less than a set threshold.

17. The numerical establishment method for rebar-concrete interface element subjected to cyclic loading according to claim 15, further comprising:
the state variable SVARS(⋅) consists of the number of cycles n, the slip s, the slip increment Δs, the slip increment of the previous incremental step Δsₚᵣₑ, the bond stress τ_{int,c} and the corresponding slip s_{unl,c} at the intersection of the reloading curve and the reduced envelope curve in the compression state, the bond stress τ_{int,t} and the corresponding slip s_{unl,t} at the intersection of the reloading curve and the reduced envelope curve in the tension state, the residual bond stresses τ_{res,c} and τ_{res,t}, and the historical maximum slip values s_{max,c} and s_{max,t}.
